(19) United States
(12) Patent Application Publication
(10) Pub. No.: US 2013/0090221 A1
(43) Pub. Date: Apr. 11, 2013

(54) Apparatus And Methods For Folding Paper Boxes

(71) Applicant: Jeremy Peter Green, Ladera Ranch, CA (US)

(72) Inventor: Jeremy Peter Green, Ladera Ranch, CA (US)

(73) Assignee: INTERNATIONAL PAPER COMPANY, Memphis, TN (US)

(21) Appl. No.: 13/270,354

(22) Filed: Oct. 11, 2011

(51) Int. Cl. B31B 3/00

(52) U.S. Cl. 493/162

(57) ABSTRACT

A box folding apparatus for folding box blanks into completed boxes is capable of increased production rates by utilizing two or more separate servo systems that independently control the various actuating drive mechanisms associated with the advancing and folding of the box blanks along the production line. Certain actuating drive mechanisms to be operating at different speeds in order to reduce the lag time normally associated with prior art solid drive box folding machinery which normally operate at a single speed. Critical actuating motions used in the process of folding and advancing the box blanks can be performed at a different speed than other non-critical actuating motions.

### BACKGROUND OF THE INVENTION

1. Field of the Invention

The present invention relates generally to apparatus and methods for folding paper boxes and more specifically to apparatus and methods for providing accurate and high-speed mechanical placement of box blanks relative to automated folding mechanisms in order to increase production rates while still creating boxes having good structural integrity.

2. Description of Related Art

During the manufacture of boxes, box blanks are advanced along a paper line for diverse folding and gluing operations. These box blanks usually have “score lines” and “fold lines” that are used to divide the blank into various sections which may include major and minor flaps that can be folded and glued together to form the finished box. During folding operations, the sections and flaps are folded about the score lines and fold lines to produce the sides, top and bottom of a completed box. The folding operations are usually accomplished by automated machinery designed to place a sufficient amount of glue or adhesive on select portions of the box blank along with actuating mechanisms which are specifically designed to contact and fold the various flaps and tabs that are pre-formed on the blank. The folds and tabs of the blank also may be required to be pressed for a time duration to effect a satisfactory glued joint to produce the completed box structure.

In certain box structures, there is often a need for precise placement of the folds and tabs relative to the remaining blank in order to compete a box having strict dimensional tolerances. As such, the machinery used to fold and form the completed box structure must be able to properly fold the blank along the fold lines and score lines to achieve a box that will withstand the burst strength associated with that particular box. Boxes are designed for numerous applications and usually require appropriate strength for a given application. For example, boxes or “flats” used for holding perishable food products, such as vegetables and fruit, often require the boxes to be stacked one upon another for shipping purposes. These type of boxes thus may require additional support structure to handle the weight that may be exerted on the box once stacked. These type of boxes also may require special structural flaps and openings to engage another box that may be stacked upon it. Accordingly, such boxes that are improperly folded and glued can result in box collapse which can cause an avalanche effect to boxes that are stacked on top of such a defective box.

Prior art apparatus for folding preformed blanks into boxes include conveyor based apparatus that engages one or more central panels of the blanks and advances the blanks along the paper line. Continuous folding belt systems can work quite well with thin cardboard or boxes. However, operating problems can result when these folding belt systems are used to fold flaps onto panels of corrugated cardboard blanks After a blank is folded along a score line parallel to the grooves and ridges, the actual fold line may skew with respect to the score line. When the fold line skews, the flap may not register properly with the central panel. This is particularly evident in conventional paper box folding machines using single folding belt systems. Often, it becomes difficult to compensate for the variations in the folding characteristics introduced by shifts in the position of the score line relative to the ridges and valleys formed on the blank, particularly on a blank-by-blank basis.

Moreover, it can be difficult to maintain the belt velocity of the folding belt system, both in speed and direction, relative to the speed and direction of the surface of the blank as it travels along the paper line. If relative motion occurs between the folding belt and the surface of the blank, surface scuffing can occur. As the folding belt system usually engages the exterior surface, any such scuffing can mar the finished surface of the carton or any printing on the carton. Any such marring may produce an unusable box.

Other prior box folding equipment include mechanical rollers which are used to move the blanks through the various folding mechanisms. Slippage between the rollers and the blanks is possible which can cause the box blank to be slightly misaligned with the folding equipment possibly causing misaligned or skewed construction of the finished box. Box folding machines which utilize mechanical drive systems such as rollers for moving the blanks in a continuous fashion can be somewhat bulky and heavy as well.

One of the problems associated with prior art box folding equipment stems from the fact that most of such equipment are solid drive type machines which generally causes the line of folding and advancing machinery to operate at a single speed or a small range of speeds. As a result, it is often difficult to increase productions speeds for such equipment. When production speeds are increased to achieve a higher production rate, such equipment is usually more susceptible to misaligning the box blanks respective to the folding components of the machinery. This misalignment can lead to higher defective boxes being formed.

Thus, a need exists for apparatus and methods for setting-up box blanks in a manner to insure that folds occur along the fold lines preformed in the blank and that the blank does not crease outside of the fold lines. Also, a need exists for apparatus and methods for increasing production speed while still providing accurate mechanical placement of box blanks relative to the folding equipment. There is also a need for a box folding apparatus which is relatively lightweight and compact to allow for ease in transporting the unit and ease in initial set up. Additionally, it would be beneficial if certain functions of the high speed machinery could be run at different speeds to increase the production rate attainable by the machinery. The present invention satisfies these and other needs.

### SUMMARY OF THE INVENTION

The present invention provides a novel box folding apparatus for folding box blanks into completed boxes. The present invention is capable of increased production rates by utilizing two or more separate servo systems that independently control the various actuating drive mechanisms associated with the advancing and folding of the box blanks along the production line. Accordingly, the present invention allows certain actuating drive mechanisms to be operating at different speeds in order to reduce the lag time normally associated with prior art solid drive box folding machinery which normally operate at a single speed. The present invention allows certain critical actuating motions used in the process of folding and advancing the box blanks to be performed at lower speeds than other non-critical actuation motions that can be easily performed at much higher speeds. The use of variable speeds to advance and fold the box blanks can result in increased production speeds to form the completed box. Prior art folding apparatus generally are not capable of attaining variable speeds when performing individual actuating motions associated with either the blank feed rate or fold rate.

There are several ways to increase the speed of production of a box folding apparatus. One way is to increase the speed by which a box blank is feed or advanced into the folding mechanisms of the apparatus. In one aspect of the present invention, the box folding apparatus includes a feeding station for receiving a box blank, the feeding station including an actuating drive controlled by a first servo system. This actuating drive is designed to advance the box blanks from a first feed position into a folding station which includes folding mechanisms for folding at least a portion of a box blank. In one aspect, the actuating drive associated with the feeding station advances a box blank from the first feed position on the feeding station into the adjacent folding station at a speed that ensures that the box blank will be properly positioned with in the folding station. A box blank which is advanced too quickly into the folding station is more susceptible to incorrect positioning with respect to the folding mechanisms used in conjunction with the folding station. In this regard, the initial advancing speed developed by the actuating drive should be sufficient to properly position the box blank in the folding station. Thereafter, the actuating drive will stop and return to its original position to engage another box blank which has already been placed, or is in the process of being placed, on the feed position of the feeding station. In this return stroke, the speed of the actuating drive is not as critical as the initial advancing speed and thus the return speed can be increased accordingly without compromising the positioning of the box blanks Since a dedicated servo system is being used to control the actuating speeds of this actuating drive, it can be run at different speeds than other mechanisms of the box folding apparatus, for example, folding mechanisms used in the folding station. Accordingly, since the return speed of the actuating drive can be easily increased, the overall speed of the folding operation also should increase.

The folding station includes a second, separate actuating drive that is associated with the folding mechanism of the folding station. This second actuating drive is, in turn, controlled by a second servo system operating independently from the first servo system. The folding operations provide another opportunity to increase the overall speed of box production. In one aspect of the present invention, this second actuating drive of the folding mechanism moves the box blank from a second feed position into the folding mechanism. As with the actuating drive associated with the feeding station, this second actuating drive can attain variable speeds as it is controlled by a second servo system. Again, the second actuating drive can move the box blank from the second feed position into the folding mechanism at a certain advancing speed since box damage must be mitigated. However, the return speed of the second actuating drive is not as critical and can be increased to speed up the folding operation. In this manner, the speed of two distinct operations of the folding process can be increased without compromising the accurate positioning of the box blank on the machinery in order to attain a properly folded box. This will only increase the overall production rate for the apparatus.

In one aspect of the present invention, the apparatus includes a feeding station with a hopper assembly for holding a stack of box blanks therein. A feed assembly is associated with the hopper assembly for engaging a box blank in the hopper assembly and moving it to the first feed position. The apparatus includes a first folding station adjacent to the feeding station having a folding mechanism for folding a portion of a box blank and a second folding station adjacent to the first folding station which also has a folding mechanism for folding the box blank into the completed box. In this aspect of the invention, the actuating assembly includes an actuating drive controlled by a first servo system which produces a forward linear stroke that moves a box blank from the feed station into the first folding station and simultaneously moves a partially-folded box blank located in the first folding station into the second folding station. This particular structure reduces the number of actuating drives needed for advancing the box blanks along the production line.

In one particular aspect, the actuating drive develops a forward linear stroke which contacts and moves a box blank from the feed position into the first folding station. The return linear stroke of the actuating drive then moves back to the feed position to advance another box blank into the first folding station. Since a servo system is utilized, variable speed can be developed to initially move the box blank at a suitable speed into the first folding station to properly align the blank relative to the folding mechanisms mounted in this station. Thereafter, the speed of the return stroke can be increased since proper box blank placement is not an issue.

In another aspect, at least one of the first and second folding stations may include an actuating drive associated with the folding mechanism which is, in turn, controlled by a second servo system operating independently from the first servo system. In one aspect, the actuating drive associated with the folding mechanism can produce a variable actuating speed to move, for example, a partially-folded box blank from a second feed position into the associated folding mechanism. In one particular aspect, the actuating drive moves a forming mandrel using a forward linear stroke which allows the forming mandrel to contact and move the box blank from the feed position into the folding mechanism. The return linear stroke of the actuating drive then moves the forming mandrel back to the feed position to again advance another blank into the folding mechanism. Since a servo system is utilized, variable speeds can be developed to move the forming mandrel and box blank at a suitable speed to allow the blank to properly enter the folding mechanism. The speed of the return stroke can be increased since placement of the box blank is not an issue in the return stroke.

These and other advantages of the present invention will become apparent from the following detailed description of preferred embodiments which, taken in conjunction with the drawings, illustrate by way of example the principles of the invention.

### BRIEF DESCRIPTION OF THE DRAWINGS

FIG. 1 is a perspective view of a box folding apparatus made in accordance with the present invention.

FIG. 2 is a side elevational view of the box folding apparatus of FIG. 1 with protective coverings removed to better show the assemblies form the present invention.

FIG. 3 is top plan view of the box folding apparatus of FIG. 1.

FIG. 4 is an end elevational view of the box folding apparatus of FIG. 1.

FIG. 5 is an end elevational view of the box folding apparatus of FIG. 1.

FIG. 6 is a perspective view showing the main frame that supports the various assemblies forming the box folding apparatus of the present invention.

FIG. 7A is perspective view of an embodiment of a feeding station which forms of the three stations of the box folding apparatus of the present invention.

FIG. 7B is a perspective view of an embodiment of a hopper assembly which can be used to form the hopper/feeder station of FIG. 7A.

FIG. 7C is a perspective view of an embodiment of a vacuum feed assembly which can be used to form the hopper/feeder station of FIG. 7A.

FIG. 7D is a side elevational view, partially in cross section, showing a box blank in the feed position with the actuating drive at the beginning of its forward stroke which advances both a box blank from the feed position of the feeding station into the first folding station and a partially-folded blank from the first folding station to the second folding station.

FIG. 7E is a side elevational view partially in cross-section showing the box blank of FIG. 7D with the actuating drive at the beginning of its forward stroke which advances both a box blank into the first folding station and a partially-folded blank into the second folding station.

FIG. 7F is a side elevational view showing a stack of paper blanks supported in the hopper assembly with one box blank in vacuum engagement with the vacuum feed assembly with the actuating drive located at the end of its forward stroke.

FIG. 7G is a side elevational view, partially in cross section, showing a stack of paper blanks supported in the hopper assembly with one box blank in vacuum engagement with the vacuum feed assembly with the actuating drive located at the end of its forward stroke.

FIG. 8A is a perspective view which shows an embodiment of a drive assembly located in the hopper/feeder station that moves the paper blanks into the first and second folding stations.

FIG. 8B is a perspective view which shows the embodiment of a drive assembly of FIG. 8A in greater detail.

FIG. 8C is an exploded view of the various components which form the drive assembly depicted in FIG. 8B.

FIG. 9A is a perspective view showing the first folding station which is located adjacent to the hopper/feeder station.

FIG. 9B is another perspective view showing the proximal relationship of first folding station and the hopper/feeder station.

FIG. 9C is a perspective view of a glue/brush assembly which can be located in the first folding station.

FIG. 10A is a perspective view showing an embodiment of a folding mechanism which can be mounted within the first folding station.

FIG. 10B is a perspective view showing the embodiment of a folding mechanism depicted in FIG. 10A.

FIG. 11A is a perspective view showing an embodiment of a folding mechanism which can be mounted in the second folding station of the box folding apparatus of the present invention.

FIG. 11B is another perspective view showing the actuating drive (with forming mandrel removed to better show the folding mechanisms mounted in the second folding station).

FIG. 11C is yet another perspective view showing the actuating drive (with forming mandrel removed to better show the folding mechanisms mounted in the second folding station).

FIG. 11D is a perspective view showing a mandrel assembly which forms part of the folding mechanism depicted in FIGS. 11A-11C.

FIG. 11E is an exploded view showing the mandrel assembly of FIG. 11D with a square-shaped mandrel attached to the sliding bar assembly.

FIG. 12A is a perspective view showing a portion of the folding mechanism which is mounted in the second folding station.

FIG. 12B is another perspective view showing a portion of the folding mechanism which is mounted in the second folding station

FIG. 12C is an exploded view of the components forming the folding mechanism depicted in FIG. 12B.

FIG. 13 is a perspective view showing an embodiment of a conveyor system which can be associated with the second folding station to remove the formed boxes from the second folding station.

FIG. 14 is a perspective view of the control unit which can be mounted on the hopper/feeder station and which controls the various mechanism used in accordance with the box folding apparatus of the present invention.

FIG. 15 is a schematic of the control unit system used with the various components of the assemblies forming the apparatus of the present invention.

### DETAILED DESCRIPTION OF THE PREFERRED EMBODIMENTS

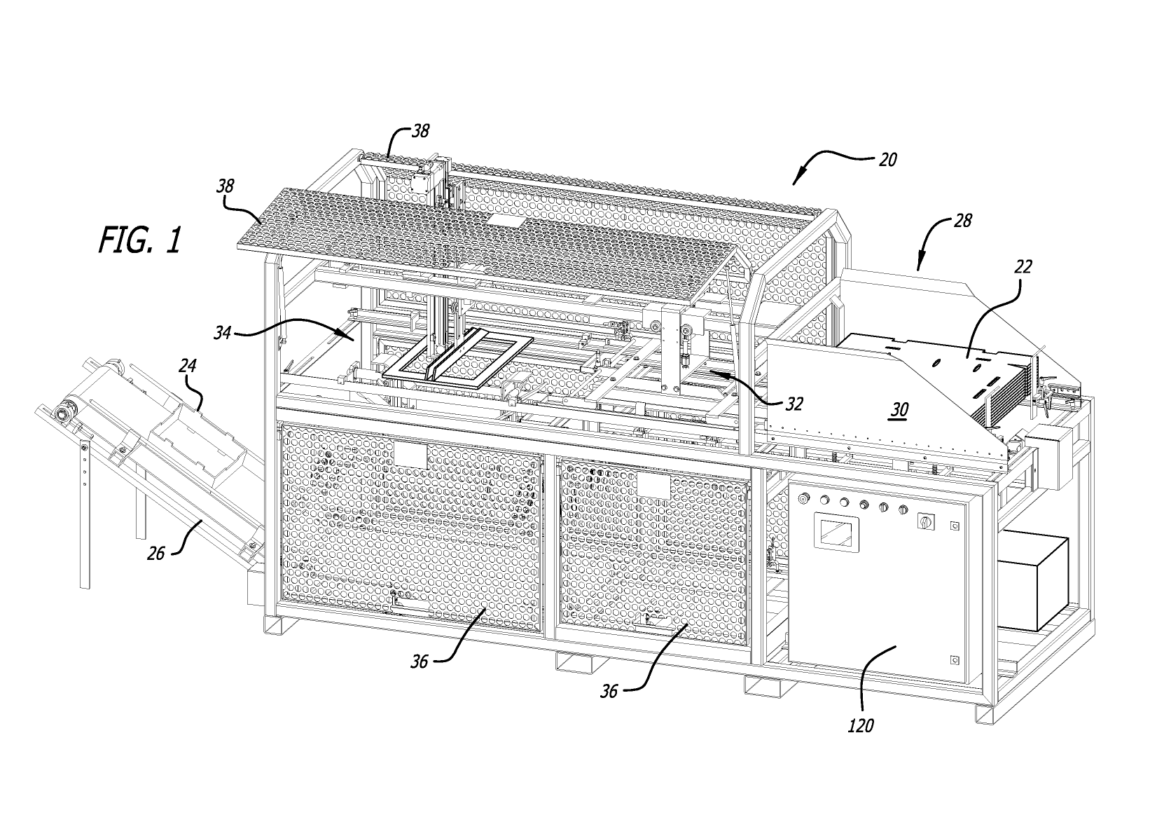

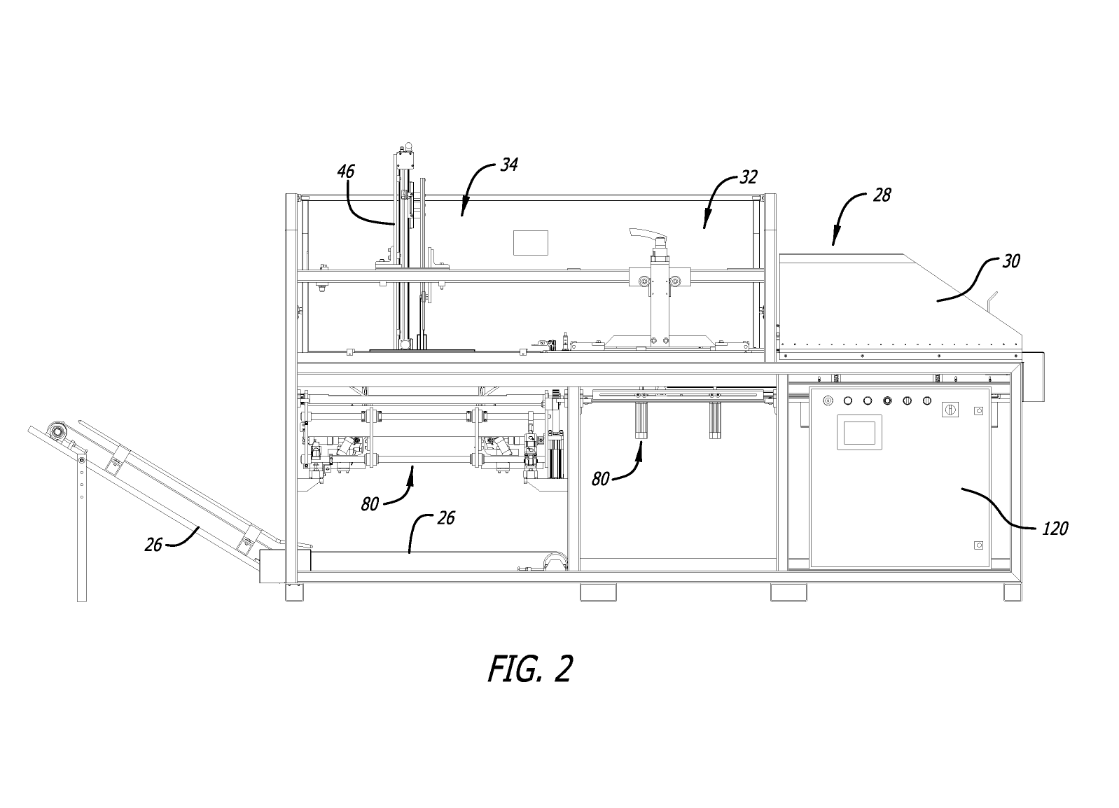

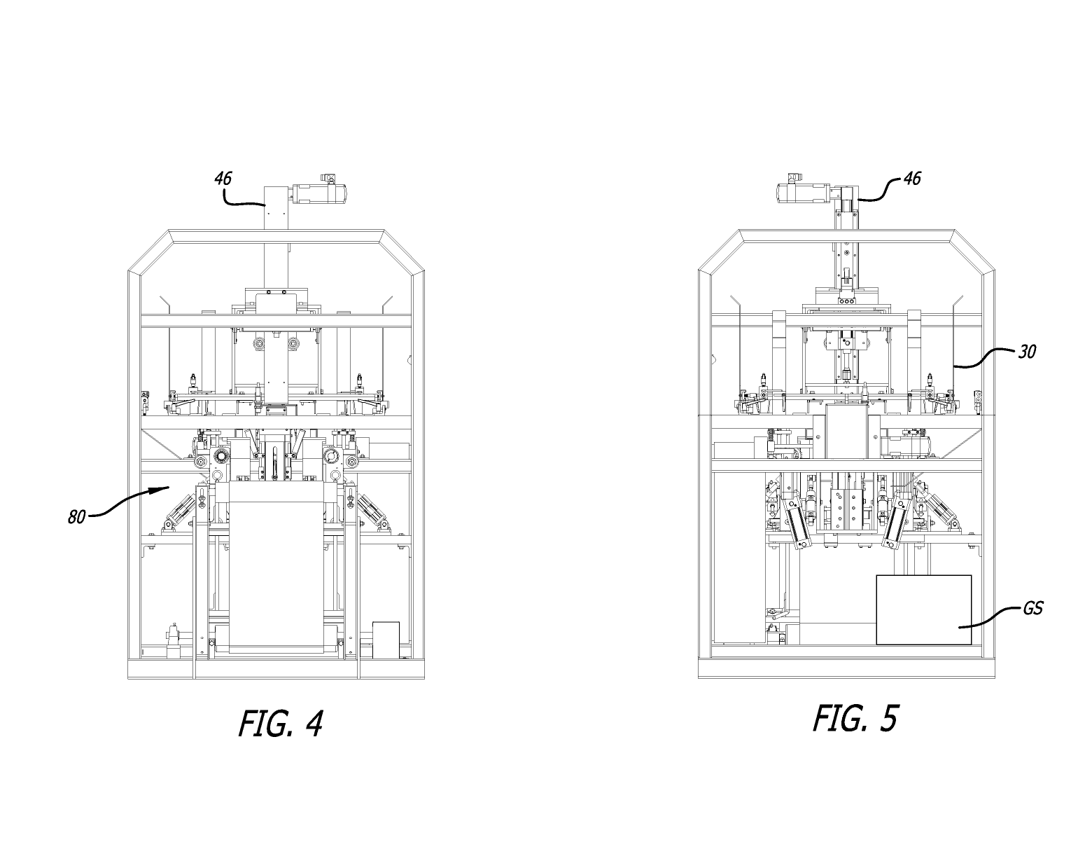

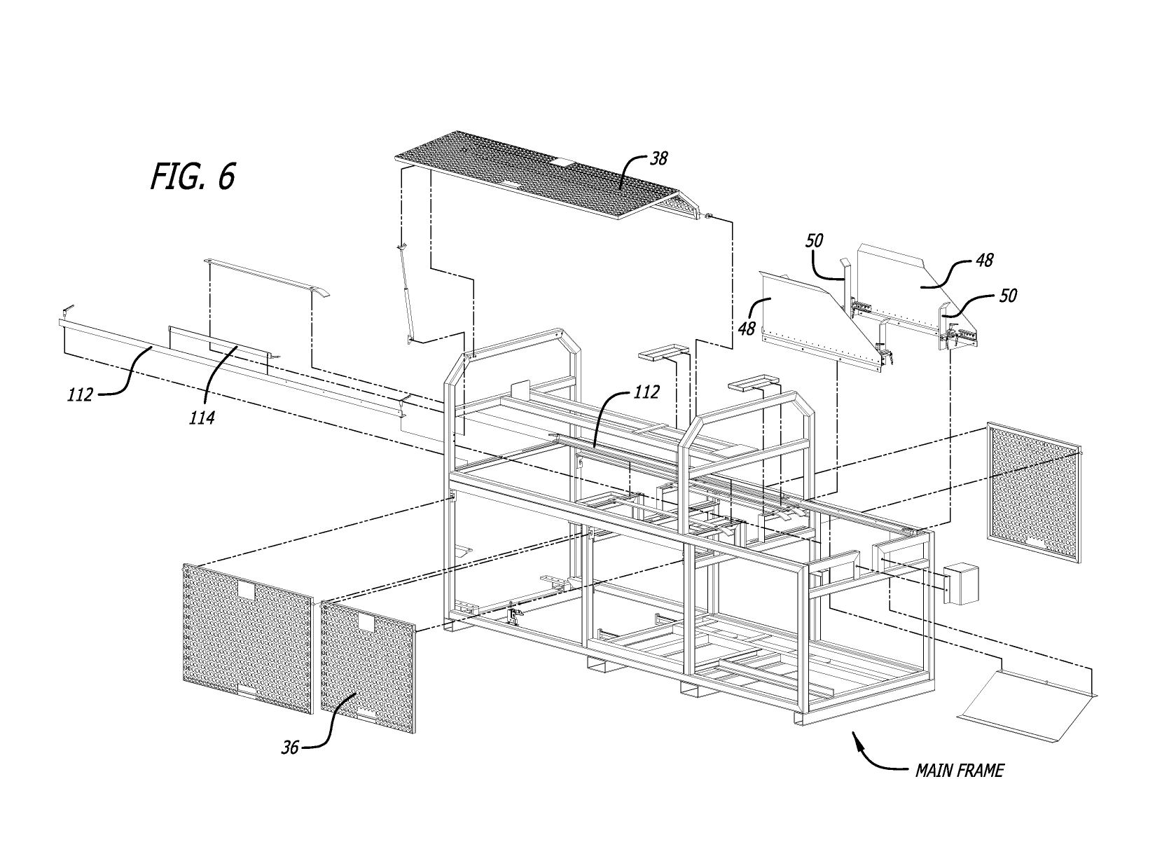

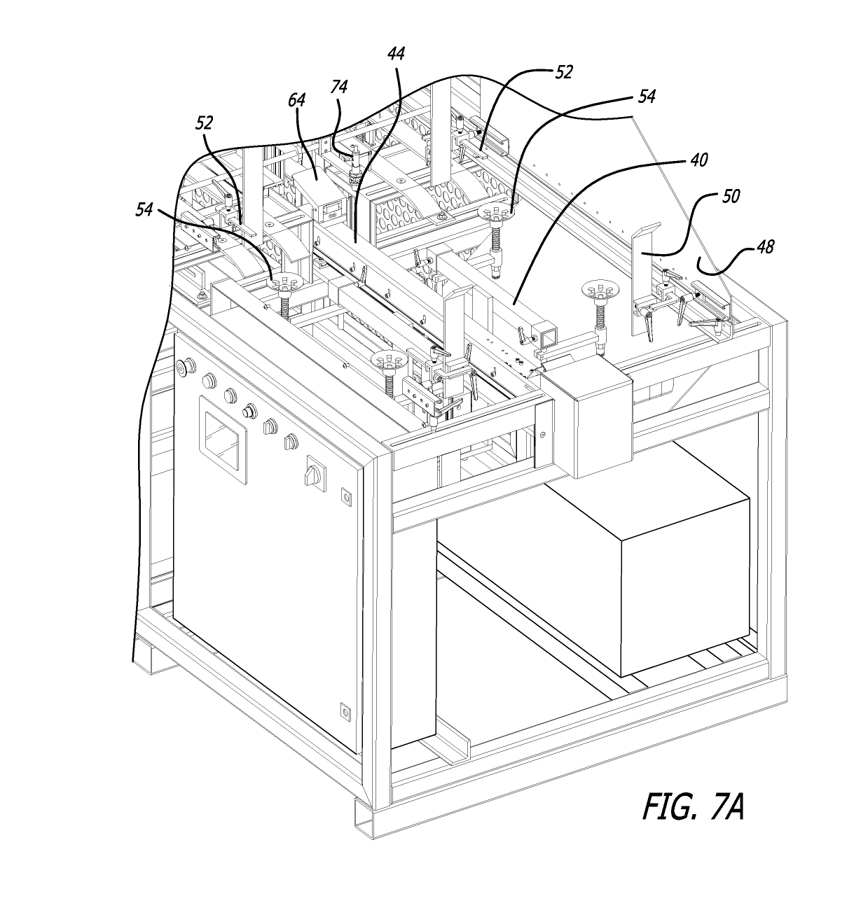

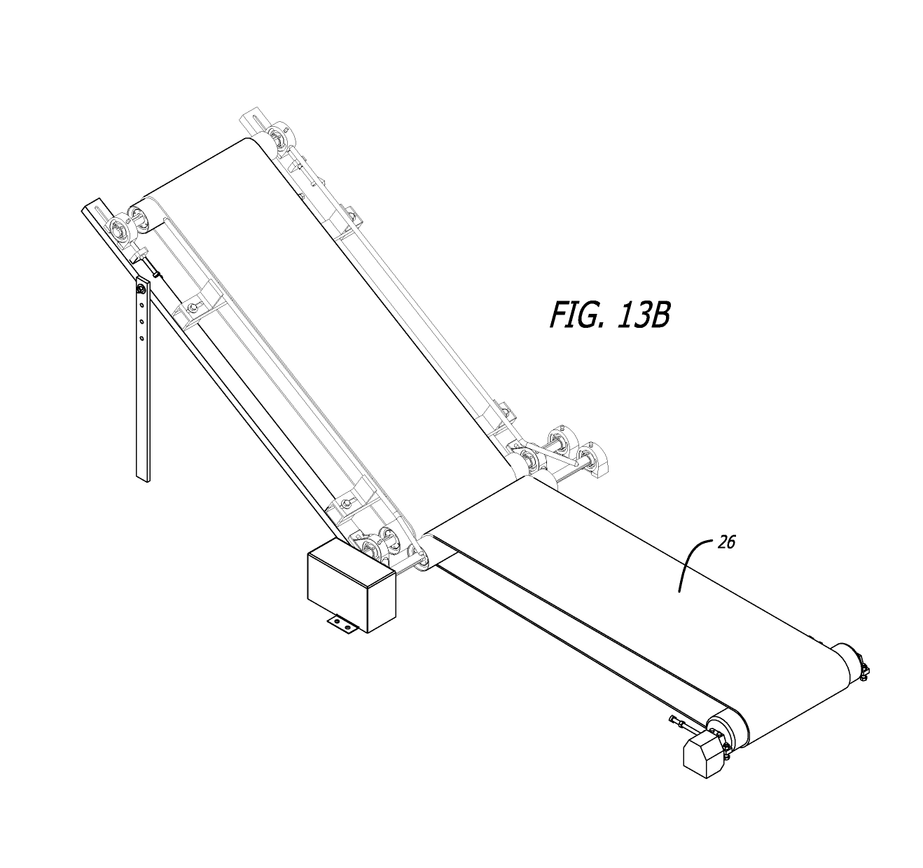

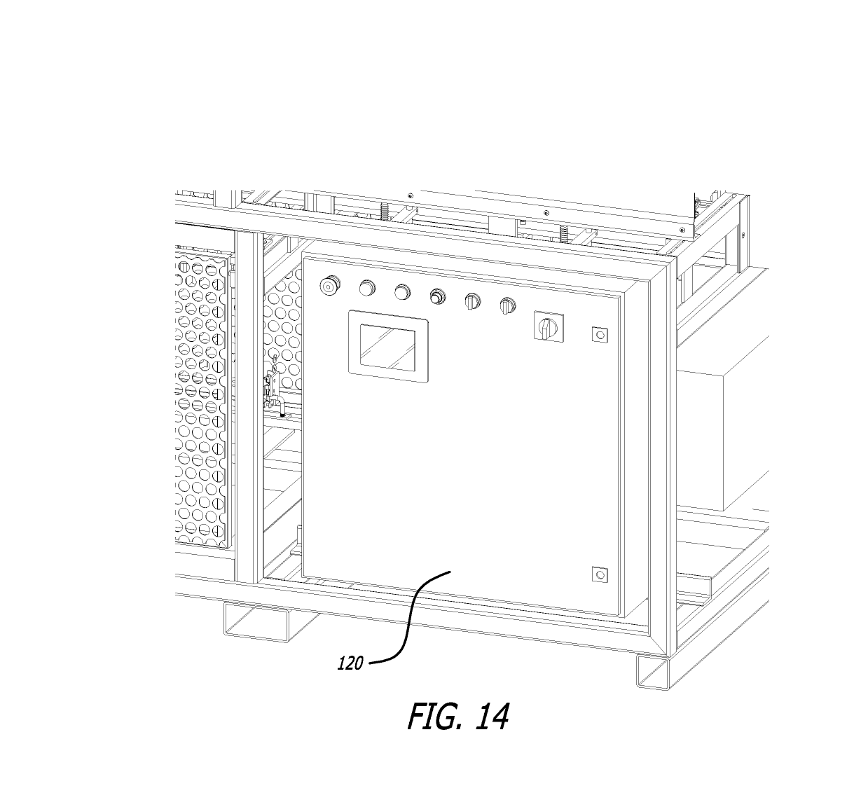

An embodiment of a novel box folding apparatus 20 made in accordance with the present invention is shown generally in FIGS. 1-5. More detailed drawings of the various actuating drives and folding assemblies making up the box folding apparatus 20 are provided in FIGS. 6-15 and will be described in greater detail below. The particular embodiment of the box folding apparatus 20 disclosed herein is specifically directed to folding a particular sized and shaped box blank. It should be appreciated that the present invention can be used with other folding mechanisms and drive assemblies to fold any number of different sized and shaped box blanks to form a finished box.

Referring specifically to FIG. 1, a commercial grade box folding apparatus 20 made in accordance with the present invention is shown. FIG. 1 shows a stack of box blanks 22 which are folded by the various folding mechanisms located within the apparatus 20 and which eventual are folded to a finished box 24 shown exiting the apparatus 20 via a conveyor belt system 26. This particular apparatus 20 utilizes three stations which advances and folds the box blanks These stations include a feeding station 28 for delivering and feeding box blanks into the folding mechanisms associated with the apparatus 20. The stack of box blanks 22 are shown stacked in a hopper assembly 30 which forms a portion of the feeding station 28. Directly adjacent to the feeding station 28 is a first folding station 32 which has particular folding mechanisms mounted therein to fold at least a portion of the box blank 22. Next, directly adjacent to the first folding station 32 is a second folding station 34 which receives the partially-folded box blank from the first folding station 32 and includes particular folding mechanisms which provide the final folding operations to complete the formed box. In this particular embodiment, the finished box 24 drops from the folding mechanisms of the second folding station 34 and drops down onto the conveyor belt system 26 which moves the boxes to a remote location for manual stacking or to an apparatus such as an automated stacker apparatus (not shown) for automated stacking

In FIG. 1, the box folding apparatus 20 is shown with protective covers 36 located at various positions around the folding stations 32 and 34 in order to keep worker's hands and objects away from the moving parts of the various folding mechanisms mounted within the folding stations. Hinged protective panels 38 can be used to allow the operator to access the machinery for servicing. The remaining figures of the box folding apparatus 20 will be shown without these protective panels for ease of viewing the components mounted in the folding stations. Additionally, the actual box folding apparatus would include various pneumatic lines, adhesive lines, hydraulic lines, and associated electrical wiring to connect the various components together to create a working apparatus. Again, for ease of viewing, such lines and wiring, including pneumatic regulators and pneumatic sources have been omitted from the drawings to allow the reader to better see the mechanisms and drives associated with the apparatus 20.

Initially, an operator feeds a stack of box blanks 22 into the hopper assembly 30 of the feeding station 28 located at one end of the box folding apparatus 20. The hopper assembly 30 is designed to hold the stack of box blanks 22 for placement on a feed position located on the feeding assembly where the box blank will then be advanced into the first folding station 32. In the particular embodiment disclosed herein, the hopper assembly 28 is a bottom fed device which means that the bottom most box blank in the stack is moved in a downward fashion onto the feed position located on the feeding station 28. It should be appreciated that top fed hoppers and related apparatus for feeding the top most box blank alternatively could be used as well as manual feeding of individual box blanks into the feeding station. However, in this particular embodiment, bottom feeding from the hopper assembly 28 provides for a quick and easy mechanism for feeding box blanks 22 into the processing machinery.

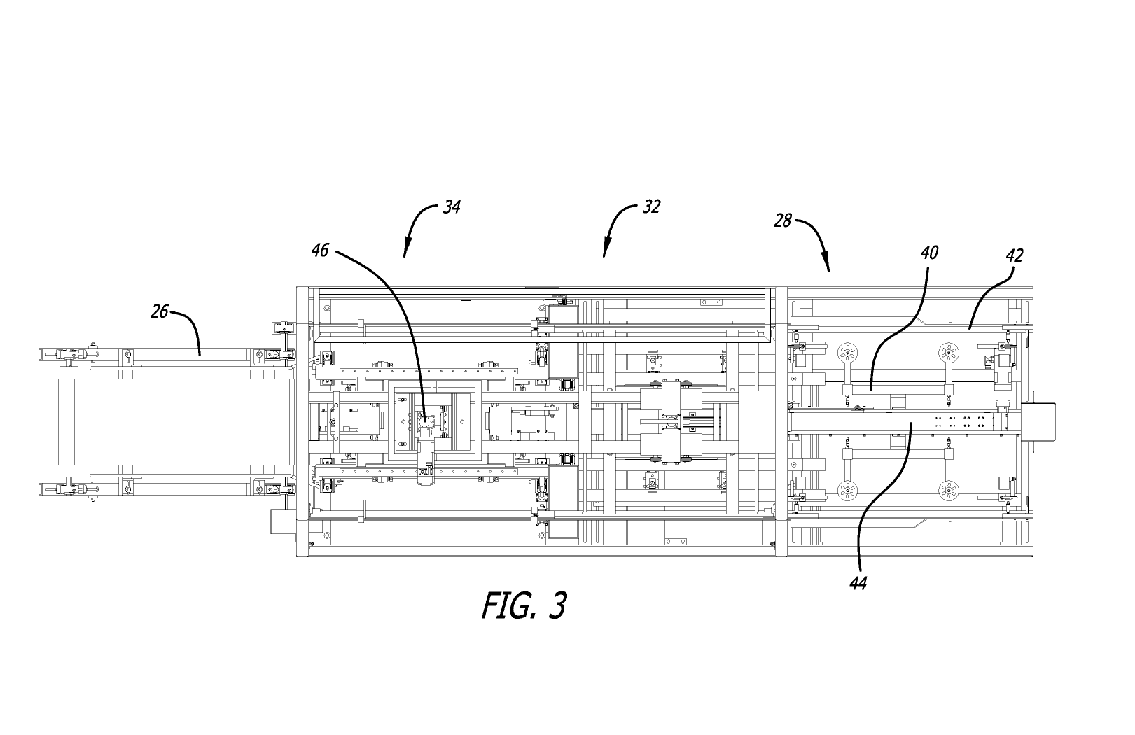

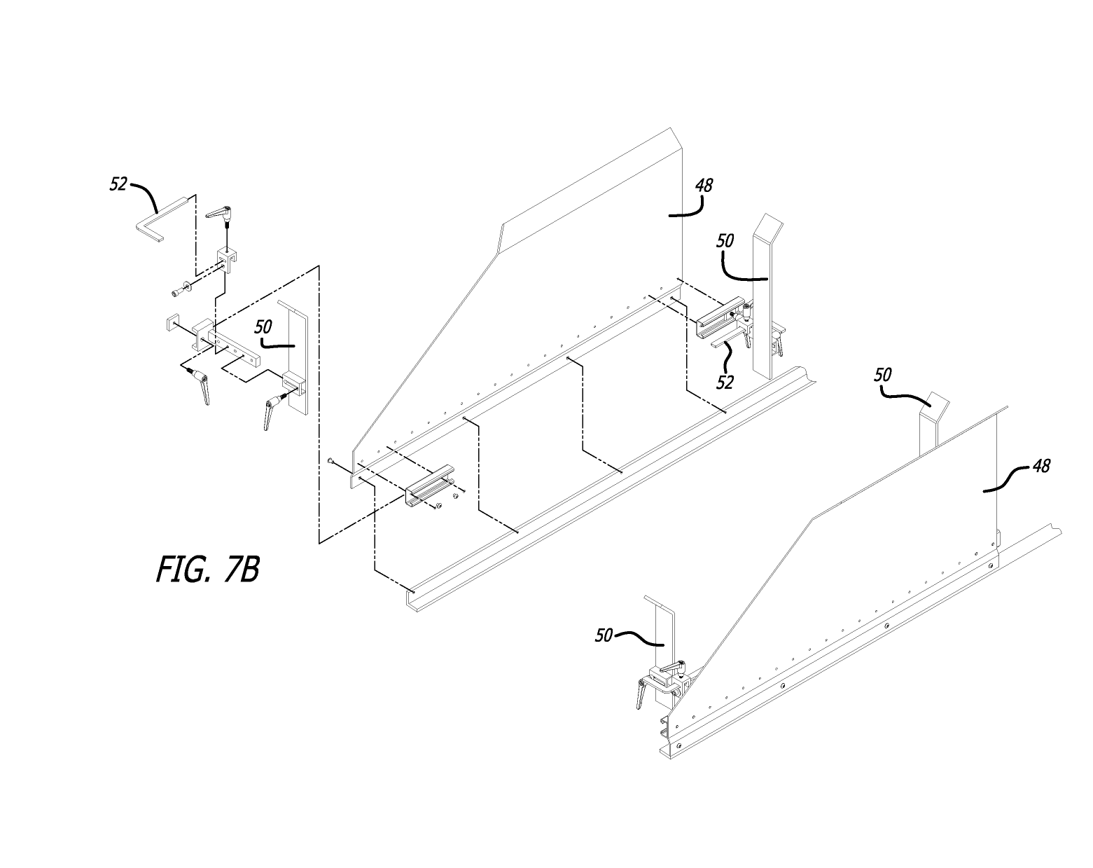

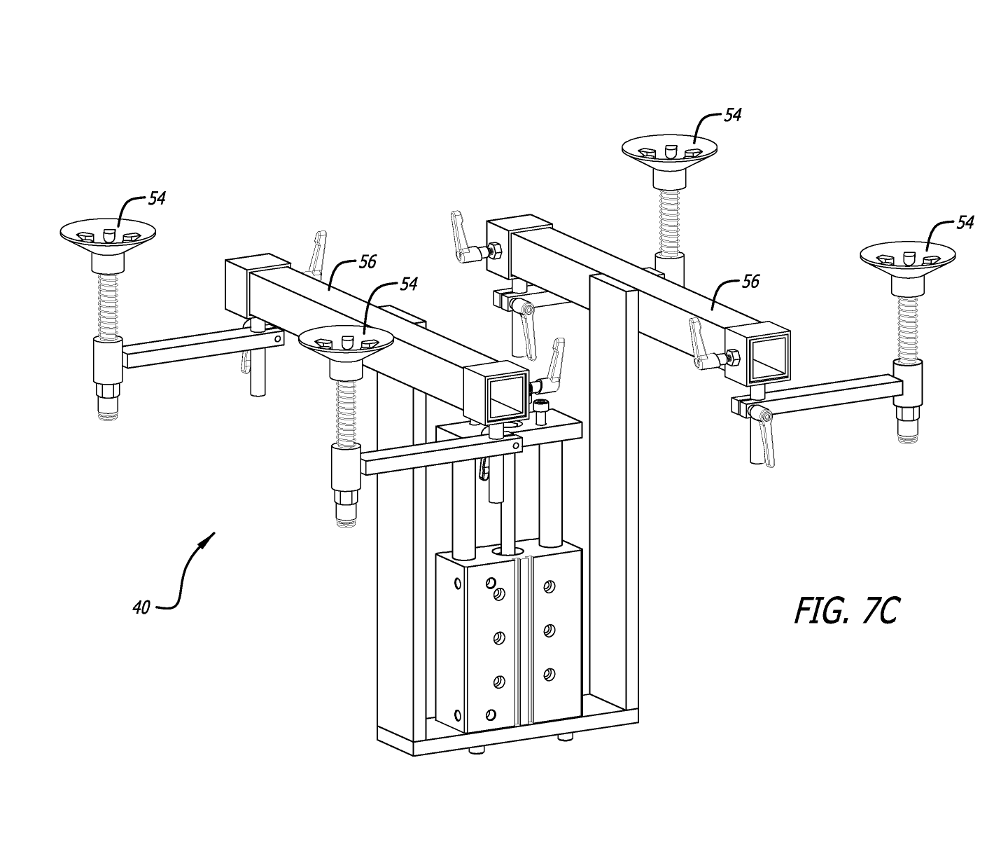

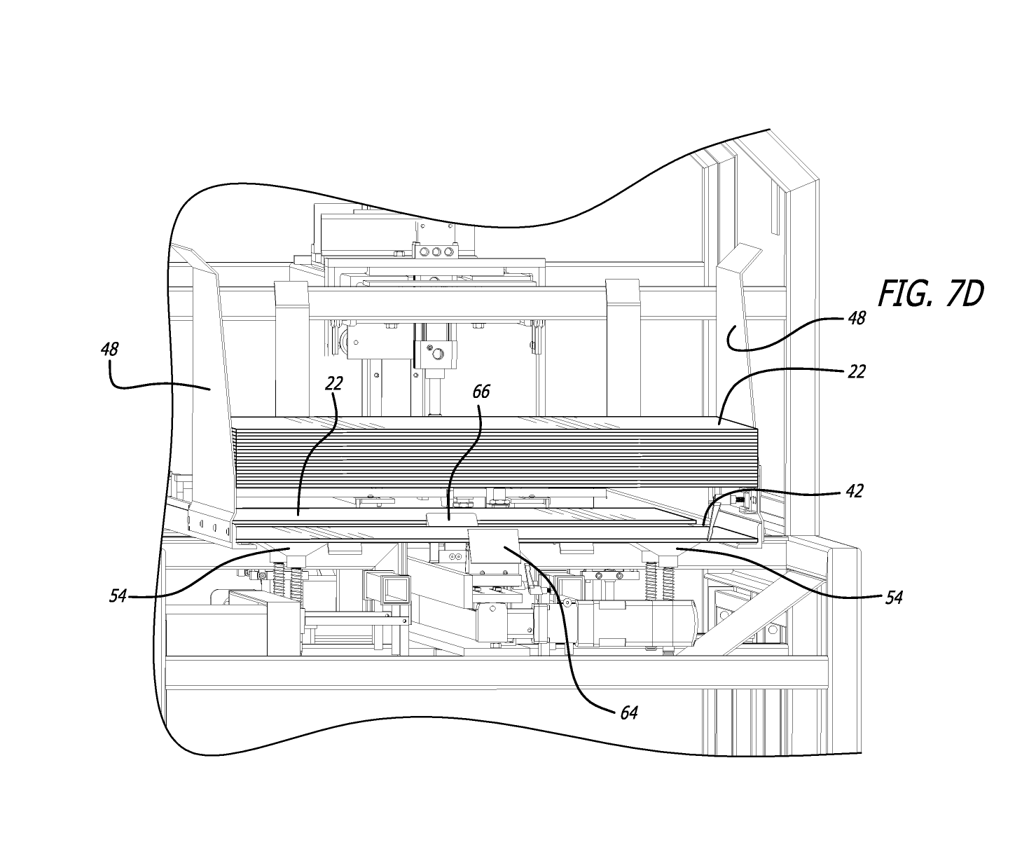

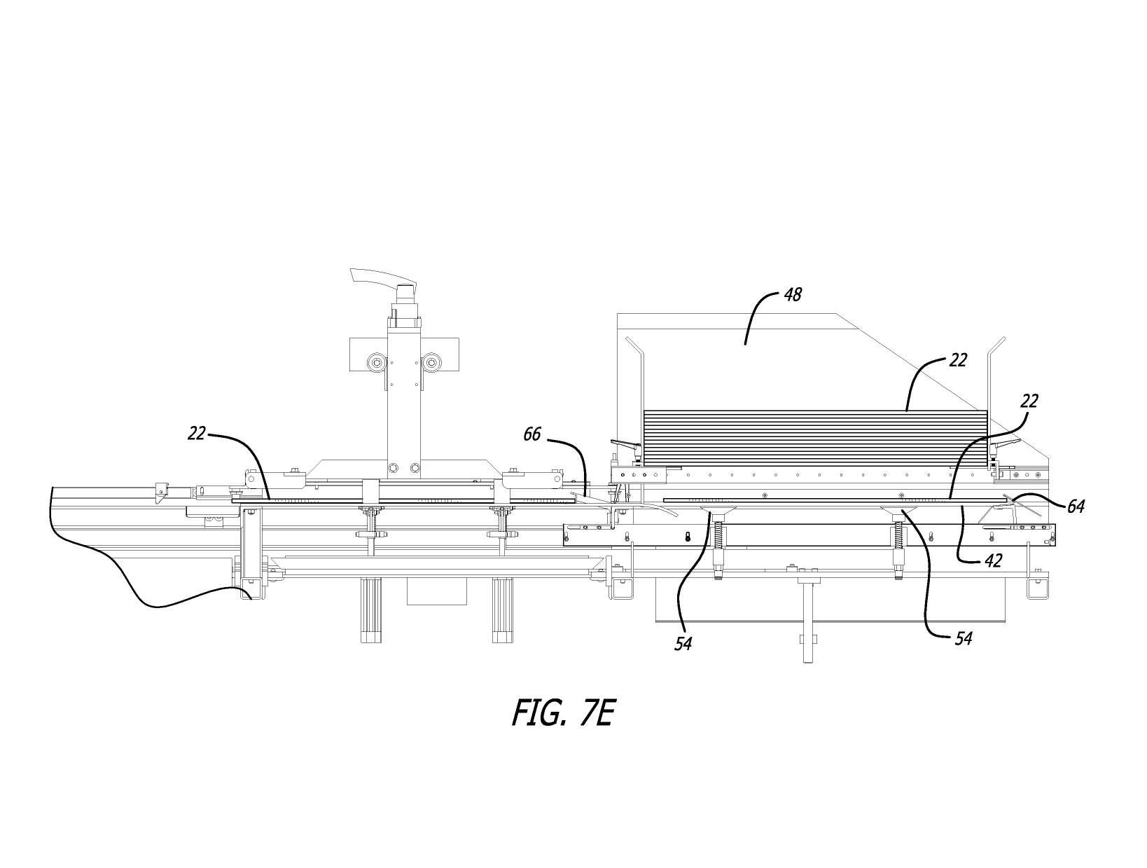

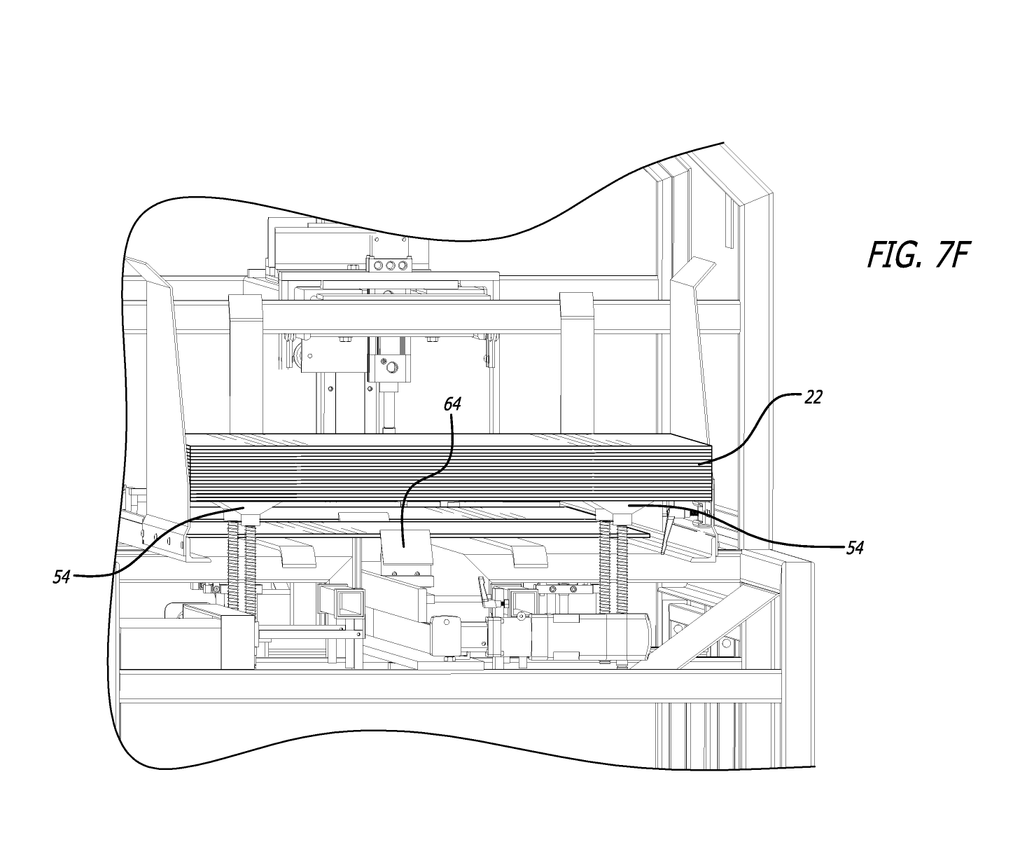

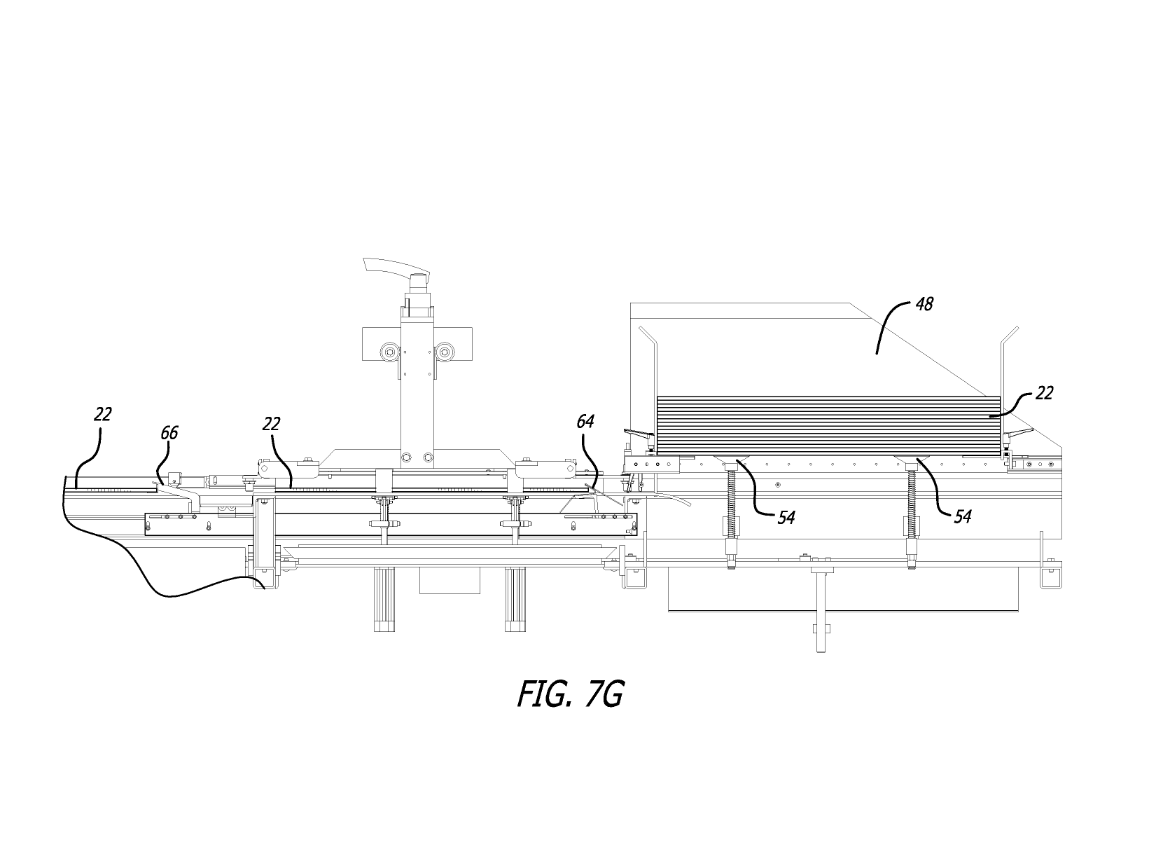

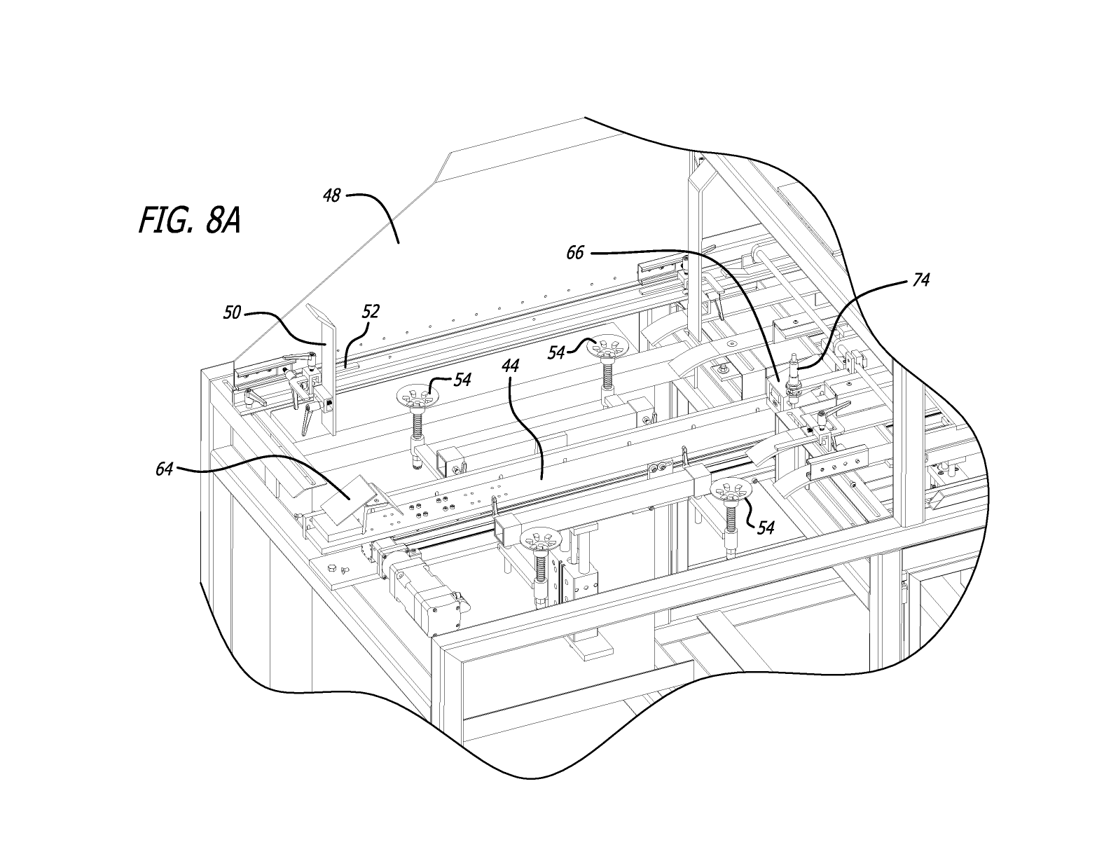

The bottom box blank of the stack can be moved from the hopper assembly 30 to the feed position utilizing, for example, a vacuum feed assembly 40 (shown in greater details in FIGS. 7A, 7C and 7D-7G and described in greater detail below). FIG. 3 shows a good plan view of the positioning of the vacuum assembly 40 on the feeding station 28. In use, the vacuum assembly 40 moves the blank (not shown in FIG. 3) into the feed position 42 defined on the feeding station 28. This feed position 42 is best shown in FIG. 7G. Still other ways of feeding the apparatus can be implemented.

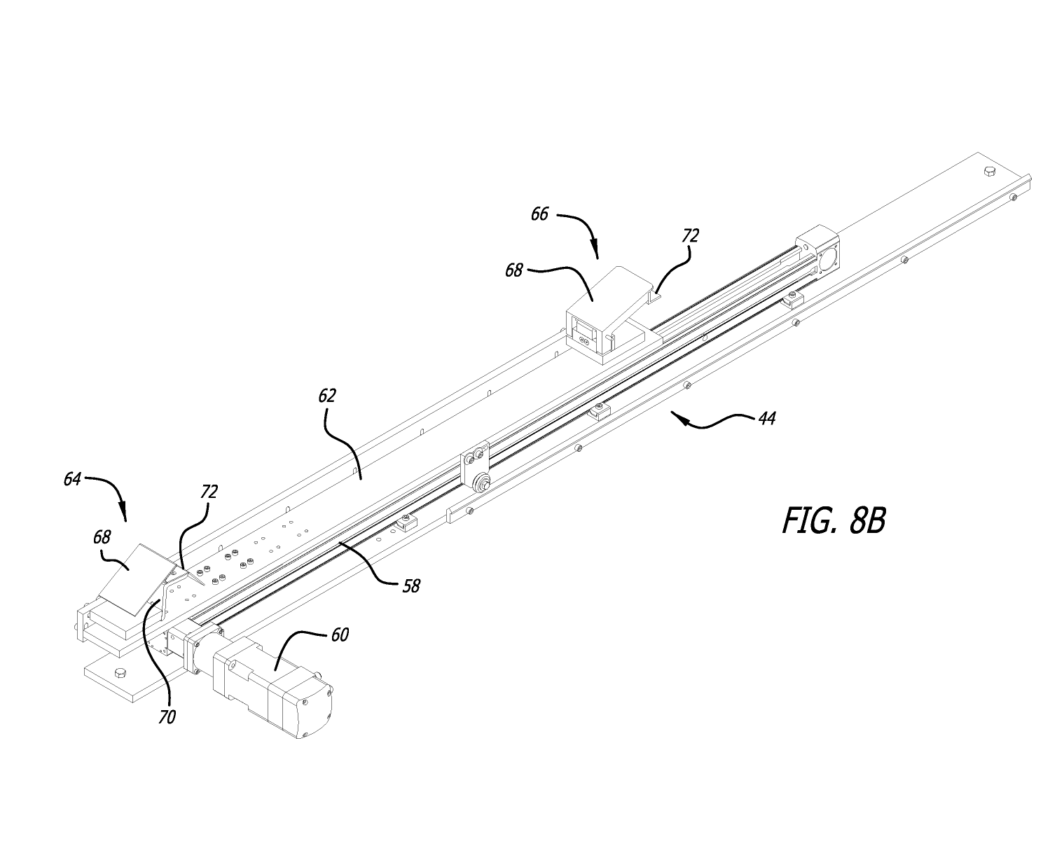

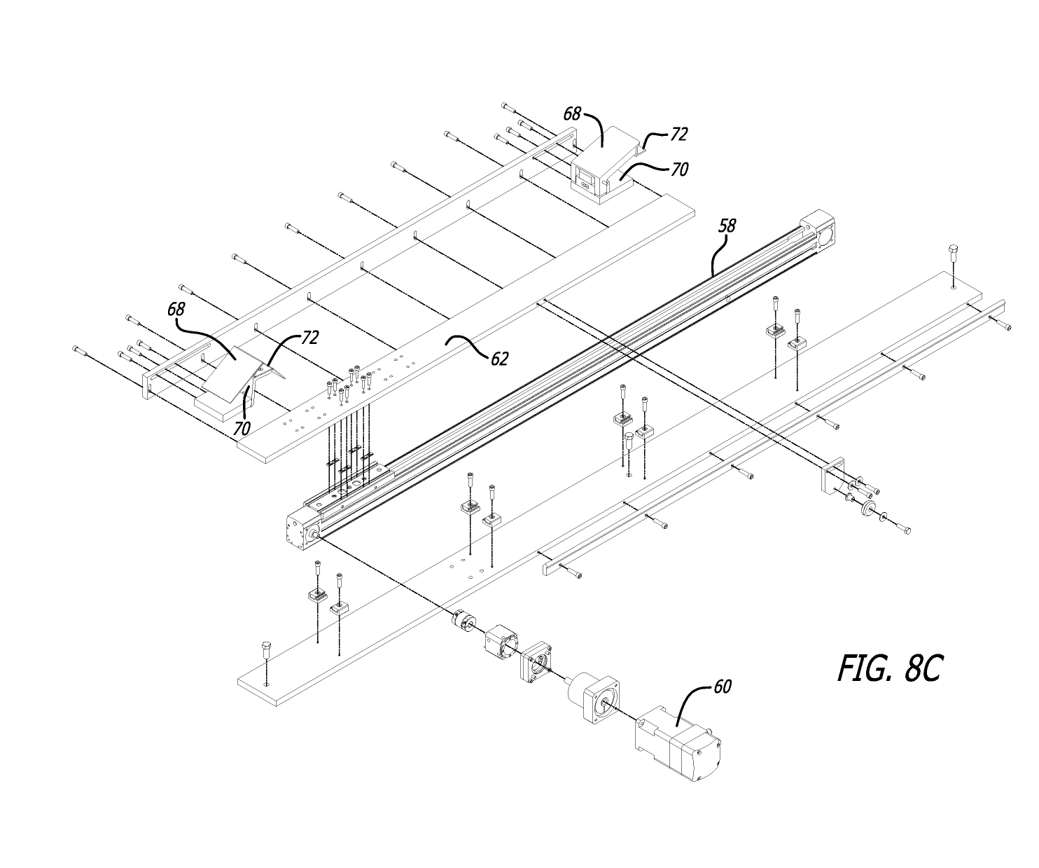

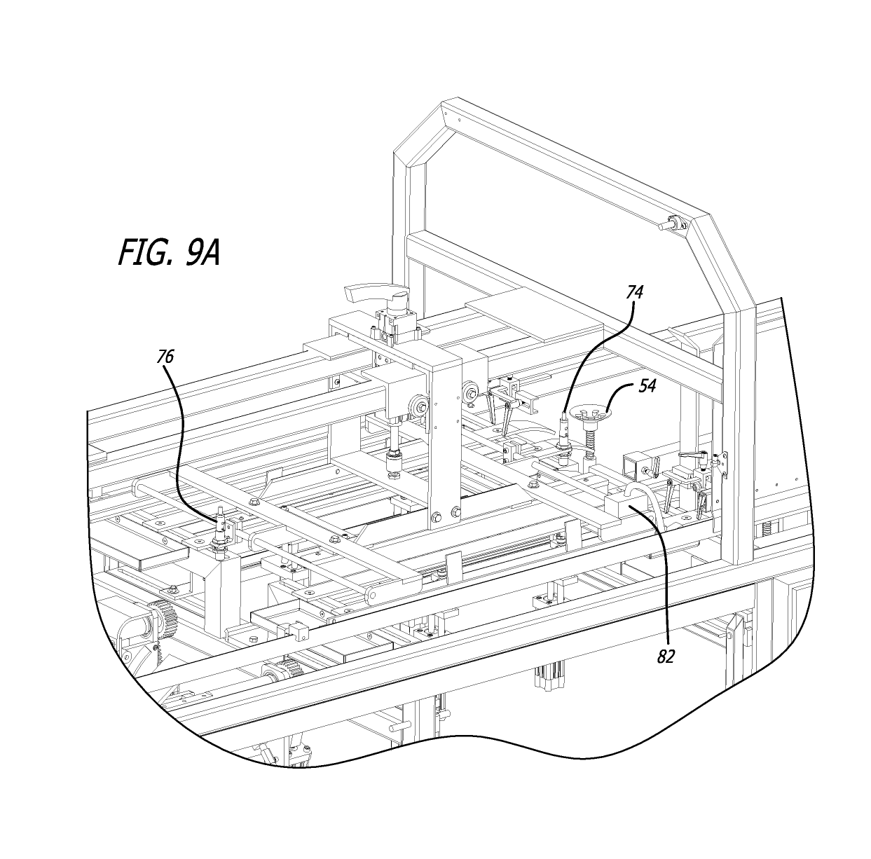

Once a box blank 22 has been placed onto the feed position 42 of the feeding station 28, an actuating drive 44 (shown in greater detail in FIGS. 7A and 8A-8C and described in greater detail below) associated with the box folding apparatus 20 which will move the box blank 22 into proper position within the first folding station 32. FIG. 3 also show a good plan view of this actuating drive 44 as it is positioned on the feeding station 28. The actuating drive 44 is controlled by a servo system which provides variable speed control to allow the actuating drive 44 to move at different speeds during the feeding process. For example, in the present embodiment, the actuating drive 44 provides a forward linear stroke to move the box blank 22 from the feed position 42 into the first folding station 32. The sequence of advancement and return of the actuating drive is best shown in FIGS. 7D-7G. The actuating drive 44 can advance the box blank 22 at a first speed which is fast enough to keep the production speed high, but is slow enough to ensure proper placement of the box blank 22 with respect to the folding mechanisms 80 of the first folding station 32. Thereafter, components associated with the actuating drive 44 must be returned to the first position 42 to engage another box blank which has or is in the process of being placed on the feed position 42. This return stroke of the actuating drive 44 can be performed at an increased speed from the first forward stroke since proper blank placement in not an issue when returning the actuating drive it its original position to advance another box blank. In this fashion, the servo system can varying the speed of the actuating drive to increase the overall speed of this particular operation without compromising the accuracy needed in positioning the box blank. The linear stroke achieved by the actuating drive 44 is shown as a preferred way for advancing the blank into the first folding station. However, still other types of actuating drives could be utilized with a servo system for advancing the box blanks into the first folding station 32. It should be appreciated that the actuating drives are not limited to linear actuators.

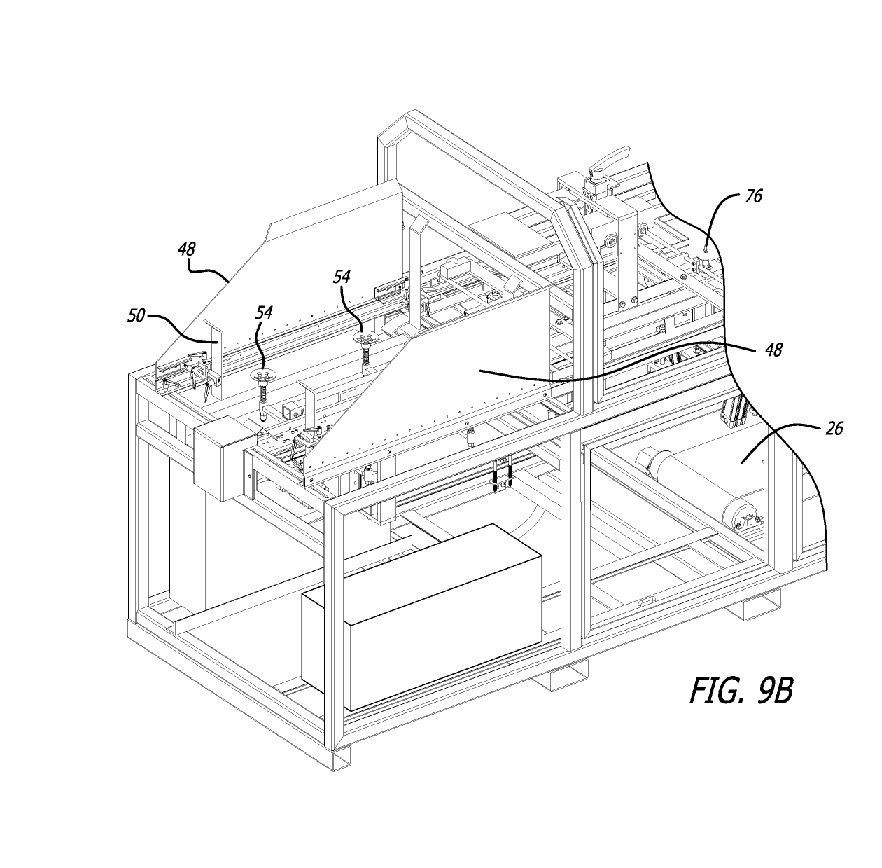

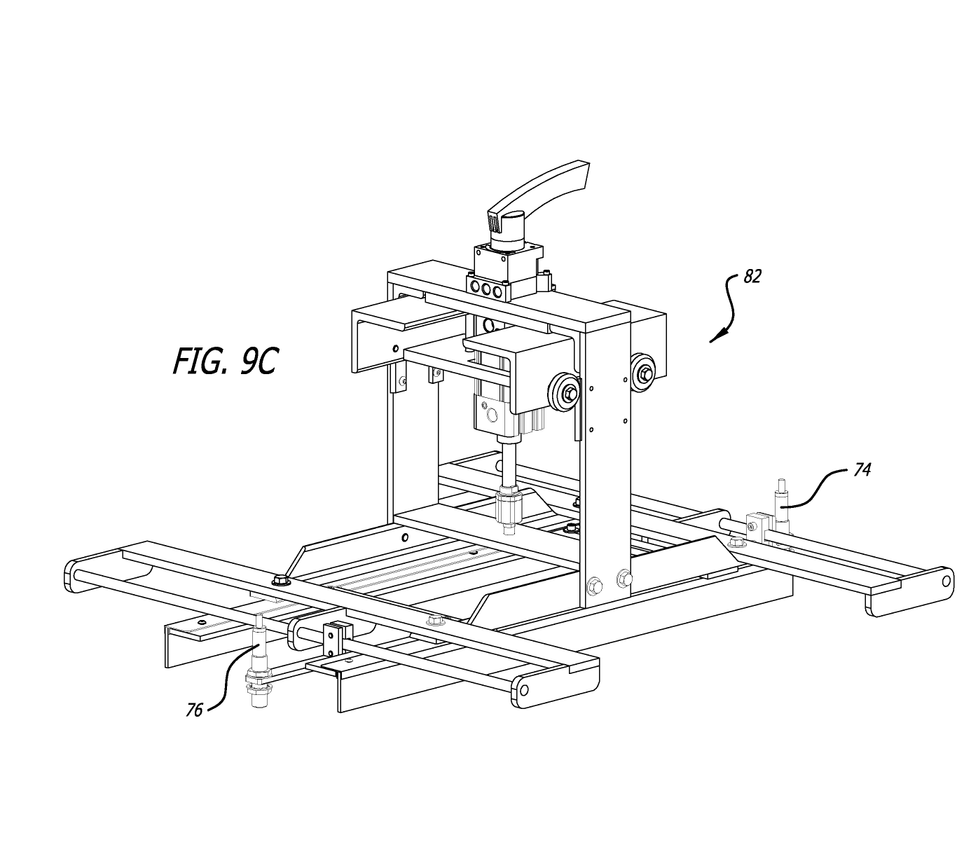

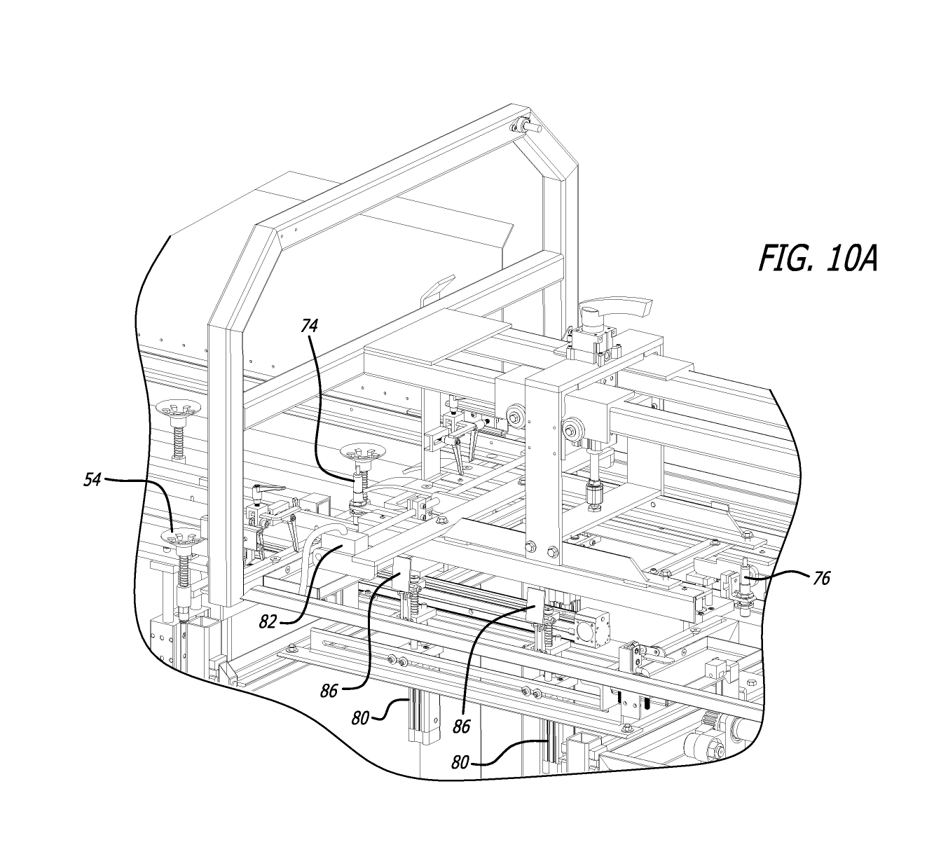

Once the blank is positioned within the first folding station 32, the associated folding mechanisms will be activated to at least fold some of the flaps/tabs formed on the box blank. In the particular first folding station described herein, four tab structures formed on the box blank are glued and folded against a portion of the blank to create a supporting structure which increases the ability of the finished box to support the weight of boxes and goods that would be stacked on the box. This is just one way to create a support structure on the box for stacking purposes. It should be noted that a glue assembly located at the entrance of the first folding station 32 is utilized to selectively apply a specific amount of glue or adhesive to the blank prior to the folding operation. The particular folding equipment used in this folding process is disclosed in greater detail below and is disclosed in FIGS. 9A-9C.

After the folding operation is completed in the first folding station 32, the partially-folded blank can now be advanced to the second folding station 34 where additional folding of the blank is performed by the equipment associated with this particular folding station. In the present embodiment, the same actuating drive 44 which moves the box blank into the first folding station 32 is also used to advance the partially-folded blank from the first folding station 32 into the second folding station 34. In this manner, a separate apparatus for advancing the blank along the line is eliminated. See FIGS. 7D-7G which shows the sequence of advancing the box blanks utilizing the actuating drive 44.

This second folding station 34 includes folding mechanisms along with a second actuating drive 46 that is utilized to position the partially-folded blank from a second feed position into the folding mechanism. This second actuating drive 46, like the first-mentioned drive above, is controlled by a servo system which brings variable speed capability to this step of the folding operation. The servo system which controls this second actuating drive 46 operates independently from the servo system controlling the first actuating drive 44 in that both actuating drives 44 and 46 can be set at individual speeds in order to achieve the operations performed by these drives 44 and 46. For this reason, these drives 44 and 46 may require a separate servo system in order to achieve the necessary variable speed requires for that particular drive. The separate servo systems would still have to coordinate with each other to only allow for advancement of box blanks when the next folding mechanism is ready to accept the blank. Otherwise, blanks could be advanced into the next station when it is not ready to accept the blank which can improperly jam up the apparatus 20.

It should be appreciate that the servo systems are controlled by a central processing unit to allow for blank advancement only when the next station is ready to accept the blank. The use of a servo system for moving and controlling the movement of the blanks along the folding mechanisms allows each drive to operate at the speed needed for that drive. The use of photo optical sensors with each servo system will ensure that blanks are not advanced into another piece of machinery until that machinery is ready to accept the blank. In this fashion, the feeding/folding operation cannot advance blanks until the machinery is ready to accept the blank.

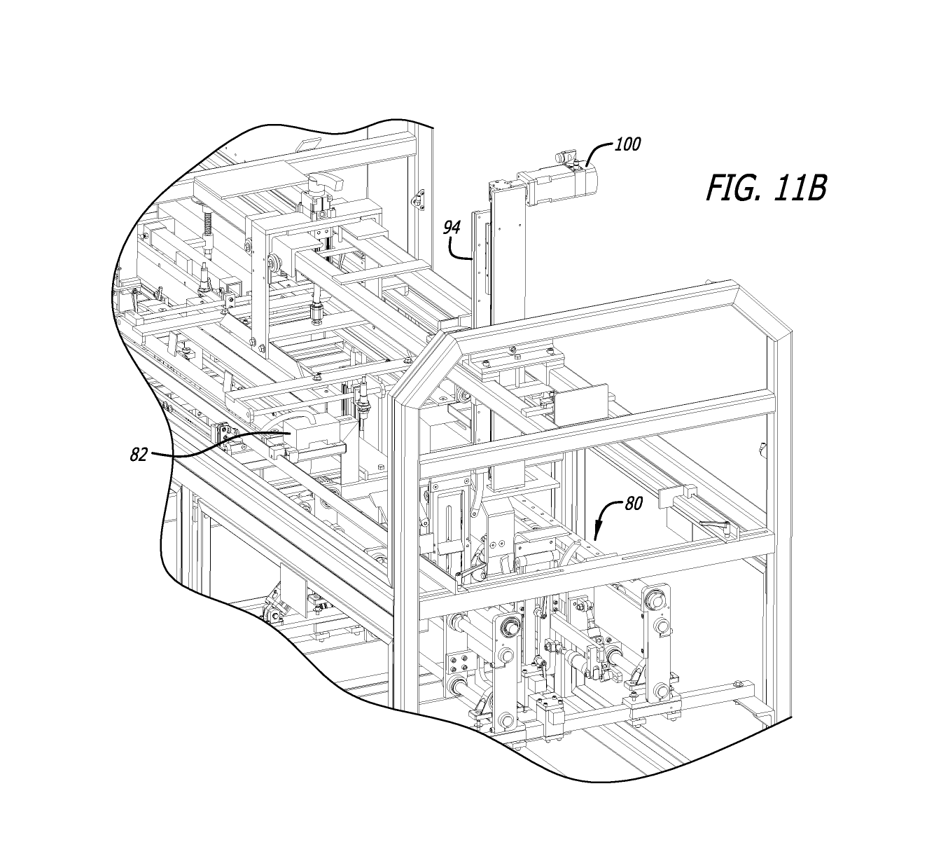

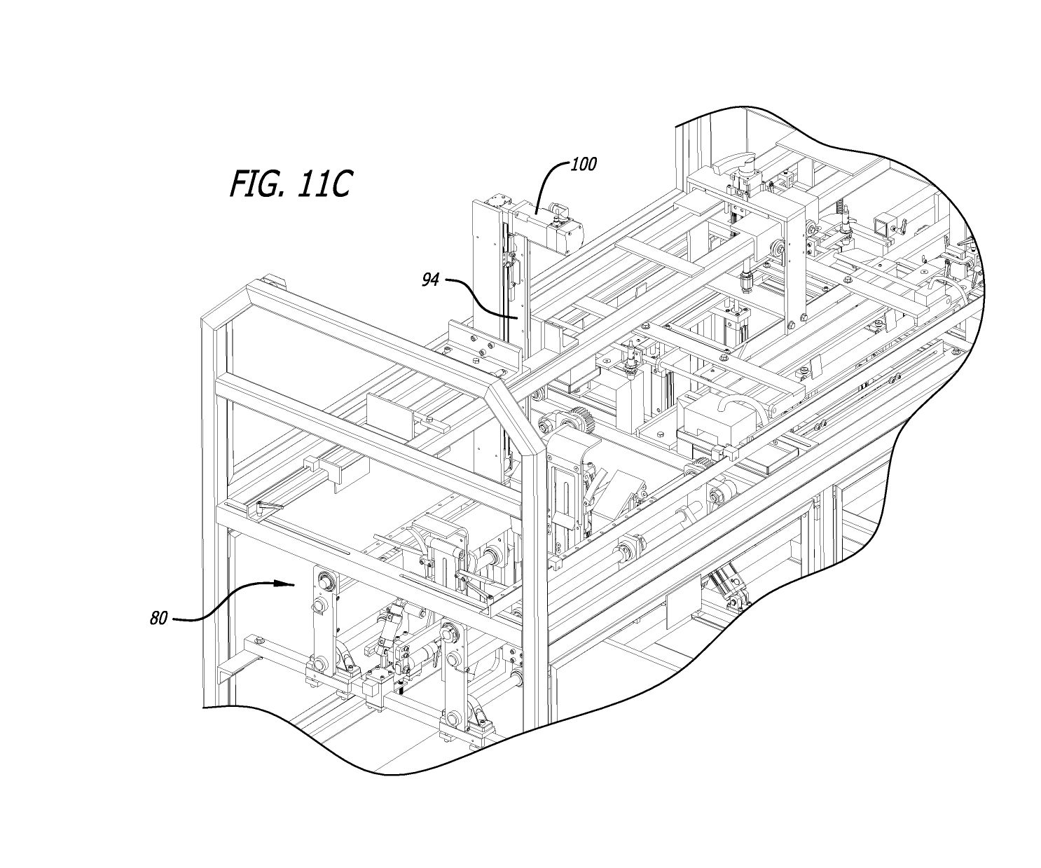

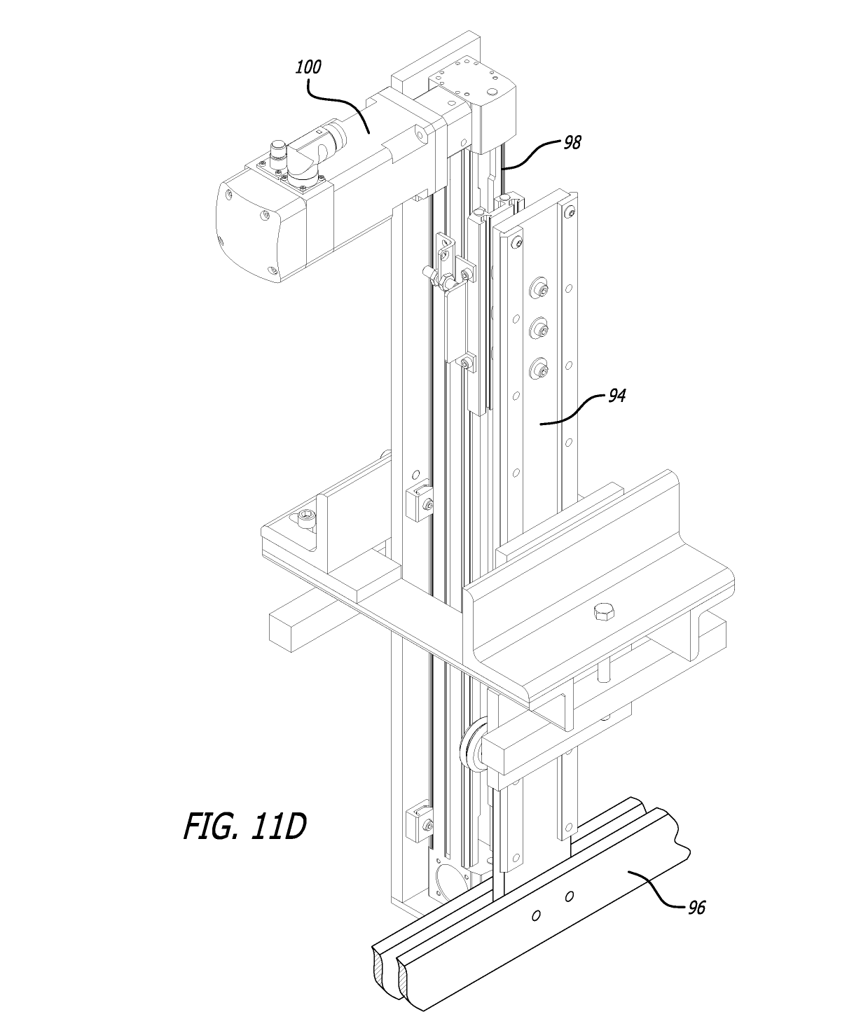

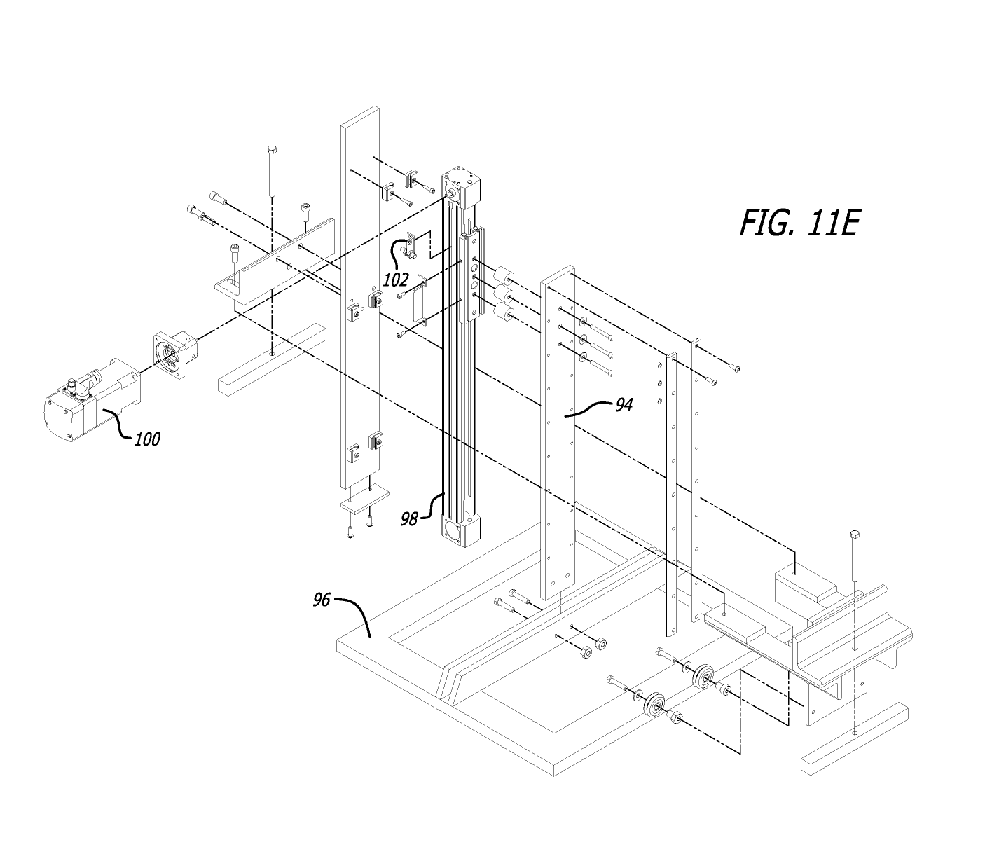

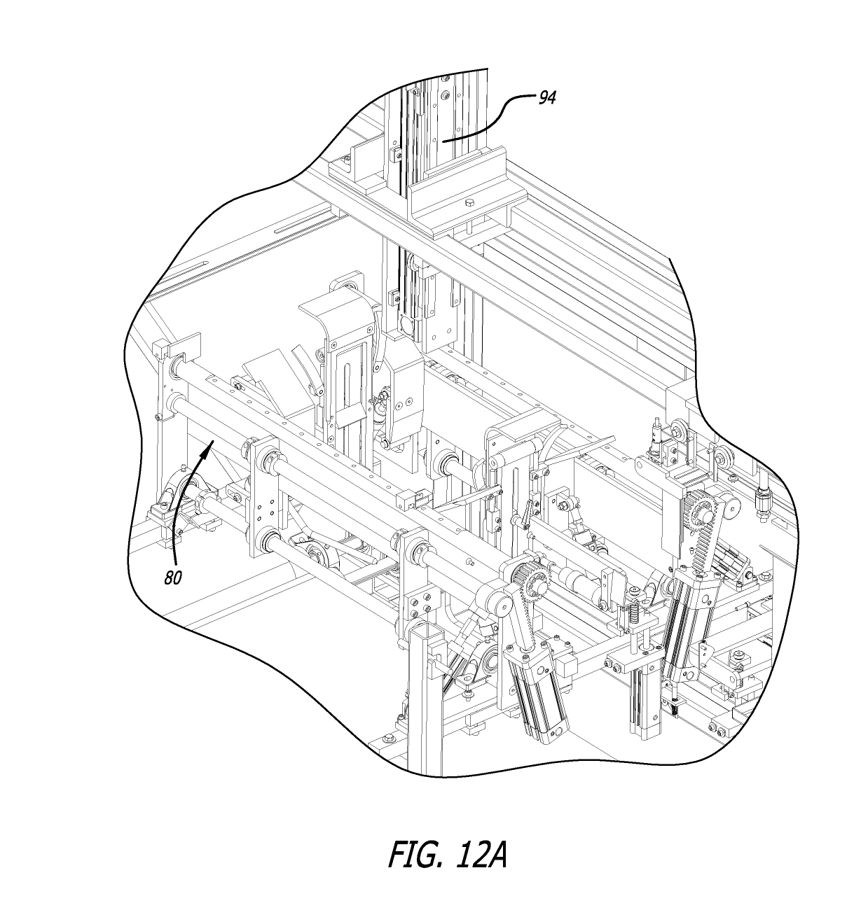

As the partially-folded box blank moves from the first folding station 32 to the second folding station 34, glue or adhesive can again be applied to select areas of the partially-folded blank. The glue applicators can be located at various positions in the first folding station. Normally, glue applicators can be positioned at the entrance of the first folding station if the first folding step requires the presence of glue on the flap(s) or tab(s) being folded. In the particular embodiment disclosed herein, the second actuating drive 46 moves a forming mandrel (shown in FIGS. 11A-11E) attached to the actuating drive 46 to move the partially-folded blank from a second feed position in station 34 into the folding mechanism associated with the folding station. Again, due to the variable speed control associated with this second actuating drive 46, the box blank can be moved at a reasonable speed into the folding mechanism while the return stroke can be done at a greater speed to increase production speed.

It should be appreciated that more or less folding stations can be utilized depending upon the structure of the box blank which is being folded. For example, some blanks could be folded at a single folding station which includes a second actuating drive used in accordance with the present invention. Additionally, a box folding apparatus could be built using additional folding stations, particularly when the box blank to be folded includes numerous folding and gluing steps. In this regard, additional actuating drives which are controlled by servo systems could be implemented into the folding operations. Additional actuating drives, such as actuating drive 44, could be used to advance the box blanks along a long line of folding stations when the box blank requires numerous folds. The same principles relating to the actuating drives 44 and 46 would apply to these additional drives as well.

As can best be seen in FIGS. 7A and 7B, the hopper assembly 30 includes a pair of hopper panels 48 which extend parallel and opposite from each other to form a defined width which matches the size of the box blanks 22 to be folded. Hopper panel end guides 50 are placed between the hopper panels 48 to create a holding area for receiving the stack of box blanks 22. The spacing of these end guides 50 and the hopper panels 48 creates a housing area that allows the stack of box blanks to be placed therein. Each hopper panel end guide 50 includes a component, referred to as a hopper stripper 52, which extends into the area defined by the panels 48 and end guides 50 to create a small surface that actually supports the stack of box blanks placed within the hopper assembly. These hopper strippers 52 are thin strips of metal which provide a small contact area for supporting the boxes. These hopper strippers 52 can be placed at strategic points in the hopper where the box blanks provide little resistance as the box blank is pulled down past the hopper stripper 52. In this regard, the hopper strippers 52 could be placed at locations where the box blank has pre-formed score lines which remain integral until the blank is pulled down by the vacuum assembly. As the box blank is pulled downward, these strippers 52 will open the score line. It should be appreciated that still other hopper assemblies could be used with the present invention.

The vacuum assembly 40 utilized to move the bottom most box blank from the stack of blanks is shown in greater detail in FIGS. 7A and 7C. This particular vacuum assembly 40 utilizes a number of spaced vacuum cups 54 designed to make contact with the bottom most box blank 22 to draw the blank 22 down onto the first feed position 42. As can be seen in FIGS. 7A and 7C, the vacuum assembly 40 utilizes four vacuum cups 54 placed in spaced positions relative to the box blank to allow the cups 54 to contact and engage the blank once the vacuum source is applied. With the vacuum cups 54 engaged with the box blank 22, the vacuum assembly can be drawn down to bring the bottom blank to the first feed position 42. The vacuum assembly 40 is designed to move up and down to engage the box blank and move it to the feed position. An actuating motor can be attached to the vacuum assembly to move the entire unit in an up and down motion. Once the box blank has been drawn down from the hopper, the vacuum source could either be shut off or the vacuum assembly could be simply lowered below the feed position to allow the cups to break their vacuum seal with the box blank. The vacuum cups 54 can be moved along the frame assembly 56 so that the cups 54 are appropriately spaced. The mounting frame assembly 56 allows the cups 54 to be moved to different positions depending on the size and shape of the box blank.

Once the bottom box blank has been drawn down into the feed position on the feeding station, the actuating drive 44 will advance the box blank, as is explained above, into the first folding station 32. As can best be seen in FIGS. 8A-8C, the particular actuating drive 44 used on the present embodiment includes a linear drive unit 58 mounted in the feeding station and connected to a servo motor 60 which forms part of the servo system. The linear drive unit 58 is designed to move a slider bar 62 in a forward and backward motion to advance the box blanks into the first and second folding stations 32 and 34. This slider bar 62 includes a front grabber assembly 64 utilized to engage an edge of the box blank (as shown in FIGS. 7 D and 7E) which has dropped into the first feed position 42 of the feeding station in order to move it into the first folding station 32. The slider bar 62 further includes a rear grabber assembly 66 located a distance away from the front grabber assembly which is used to move a partially-folded blank from the first folding station 32 to the second folding station 34. In this regard, when the actuating drive 44 is in operation, the front grabber assembly 64 will contact an edge of the blank which has been moved to the feed position 42 while the rear grabber assembly 66 contacts an edge of the partially-folded blank located in the first folding station 32 to move it into the second folding station. Thus, the actuating drive 44 is designed to move two blanks simultaneous during the folding operation.

In operation, as the slider bar 62 moves back in its return stroke to allow the front grabber assembly 64 to engage another blank that is being fed from the hopper assembly 30, the vacuum feed assembly 40 has already been moved in position to engage the next paper blank which will be moved to the feed position. The timing of the feeding operations allow the vacuum assembly 40 to be actuated once the box blank has been cleared from the feed position of the feeding station. In this fashion, the speed of the folding operation can be increased since the actuation of the vacuum feed assembly 40 can be timed and synchronized with the actuating drive 44 to reduce the time needed to feed blanks from the hopper assembly 28. Once the blank has been moved from the feeding station 28 into the first folding station 32, the folding mechanisms associated with the first folding station 32 can be implemented to create the desire amount of fold to the box blank. As is mentioned above, it should be appreciated that the first folding station 28 may include not only folding mechanisms for folding the box but also mechanisms for placing glue/adhesive onto the desired area of the blank.

The structure of the front grabber assembly 64 and rear grabber assembly 66 are somewhat similar in that a shaped engaging plate 68 is pivotally mounted to a base structure 70 that is mounted to the slider bar 62. The engaging plate 68 has a formed edge 72 that is designed to engage an edge of the box blank as the slider bar moves in a forward direction. The plate 68 is pivoted such that as the slider bar 62 moves in the return direction, the plate 68 will pivot in the event that it should make contact with the next box blank being moved into the feed position. Accordingly, the plate 68 provides a smooth surface which will allow it to slide along the length of the box blank, rather than engage it. It should be appreciated than while single forward and rear grabber assemblies 64 and 66 are disclosed in the described embodiment, it would be possible to utilize additional grabber assemblies if the size and shape of the box blanks are particularly large. For example, a cross beam could be attached to the slider bar 62 and two front grabber assemblies could be placed at the ends of the cross beam. The same structure could be used for the rear grabber assembly. The use of additional grabber assemblies allows the pushing force exerted on the end of the box blanks to be more evenly distributed.

The actuating drive 44 utilizes optical sensors 74 and 76 which are strategically placed at the entrance and exit of the first folding station 32. These optical sensors are associated with the servo systems and provide a signal once the box blank 22 begins to enter the first folding station 32 and once it exits it. This signals from these optical sensors can be used in accordance with the glue assemblies which can be placed along the folding line to signal when glue should be released onto the box blank. It should be appreciated that additional optical sensors could be utilized for providing desired signals for other functions that are being controlled during the folding operations.

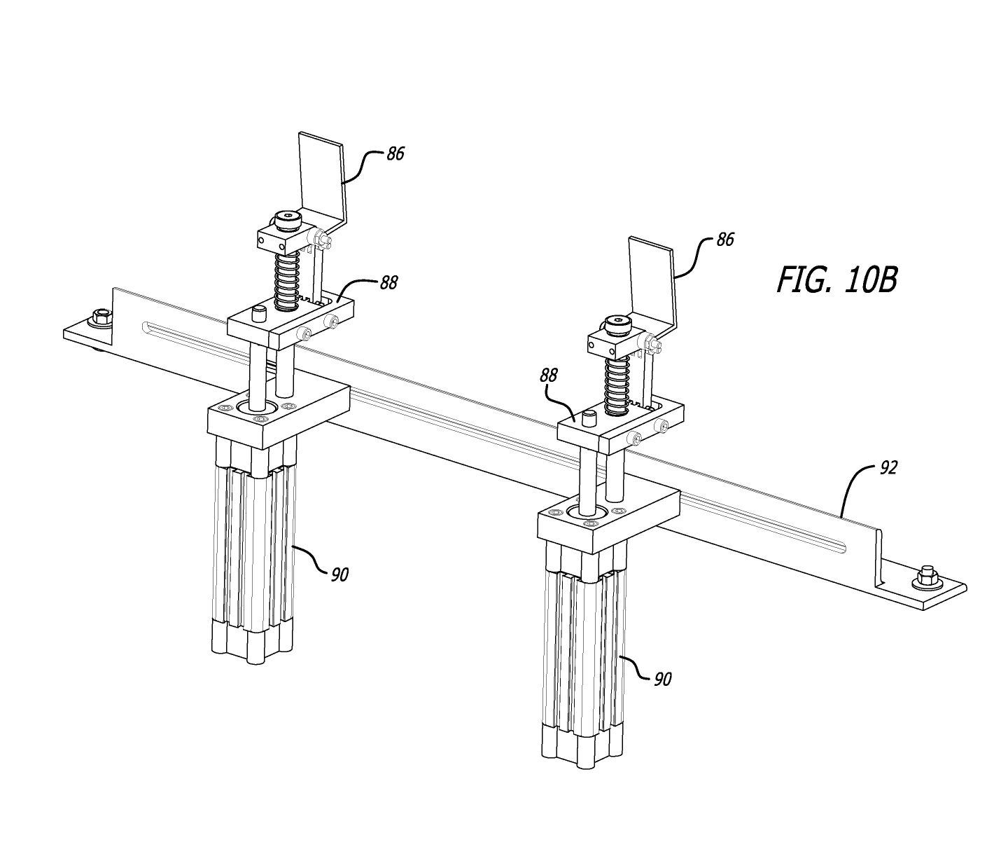

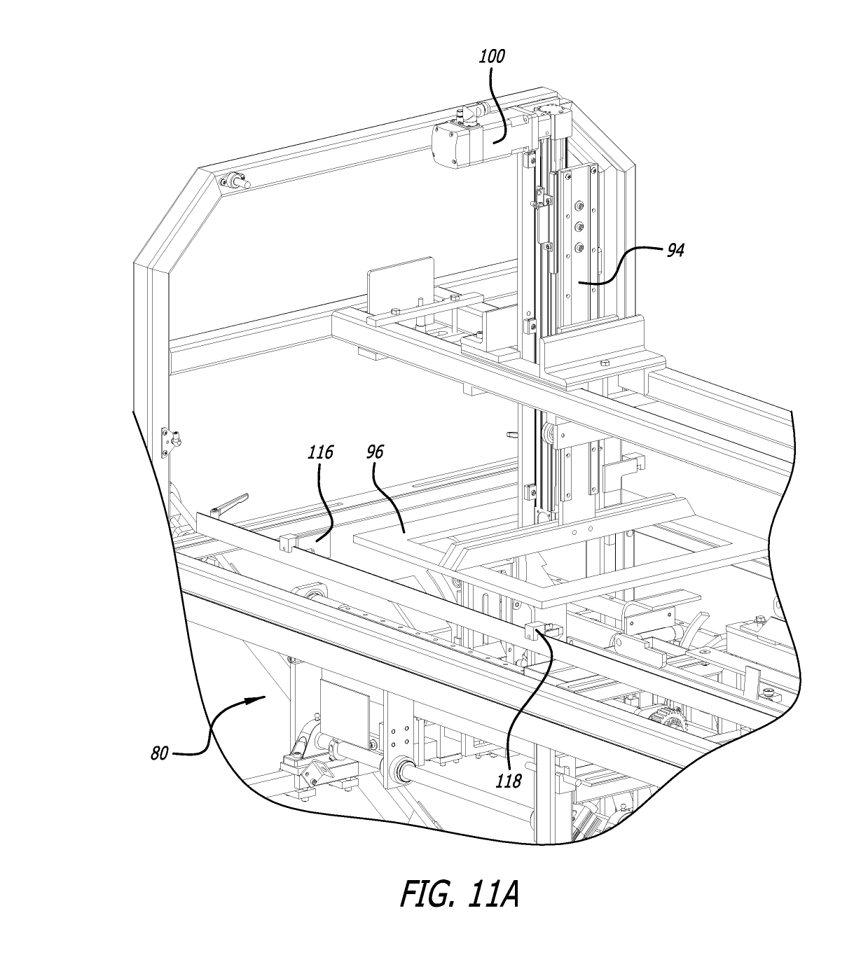

Referring now to FIGS. 10A and 10B, the folding mechanisms 80 located in the first folding station 32 will be discussed in greater detail. In the particular embodiment shown in FIGS. 10A and 10B, the box folding mechanism 80 located in the first folding station 32 is designed to fold a number of support tabs formed on the box blank. In the particular embodiment disclosed herein, there are four stack tab assemblies 80 mounted onto the main frame of the apparatus. Accordingly, four stack tabs located on the box blank will be folded over in this initial folding operation. Prior to folding these tabs of the box blank, a glue gun assembly 82 initially places a spot of adhesive/glue on the box blank where the tabs will be folded over during this first folding operation. Accordingly, the stack tabs will be glued to a portion of the paper blank to provide a strong support structure which will enable the formed boxes to be stacked on top of each other during commercial use. Again it should be appreciated that in this particular embodiment, this first folding operation is directed to the folding of four individual tabs that are formed on the paper blank and is just one of the many folding mechanisms that could be associated on this first folding station. The number of folds and type of folds which can be accomplished by this first folding station will depend upon the type of box which is to be folded by the box folding apparatus. Accordingly, the main frame (discussed in greater detail below and disclosed in FIG. 6) includes support bars and additional structural elements which can easily be used to support the other folding mechanisms, glue assemblies, optical sensors and the like that could be mounted within the folding stations. A glue supply (GS) is mounted on the main frame to supply glue via glue lines (not shown) as is needed.

The specific folding mechanisms 80 used in the first folding station 32 are shown in greater detail in FIG. 10B. While only two stack tab fold over assemblies 84 are disclosed in FIG. 10B, the specific embodiment requires four assemblies 84 since there are four stack tabs associated with the specific box blank being folded. Each assembly 84 includes an articulating compression paddle 86 connected to a mechanism 88 which allows the paddle to generally articulate about 90 degrees or more. The assembly 84 is attached to an air cylinder 90 which provides the air source to move the compression paddle 86. In use, once the blank is in position, the compression paddle 86 is raised from a lower position to push through the stack tab to break the score line. The paddle 86 then contacts the stack tab and moves it to make contact with the portion of the box blank where glue has been applied. The paddle 86 provides a brief compressive force for a short duration to allow the stack tab to bond to the blank. The compression paddle 86 is then lowered to its neutral position to allow another box blank to enter the first folding station 32. Each of the assemblies 84 are mounted to a rail 92 which allows the assemblies 84 to be moved as needed to obtain proper positioning with the tabs of the box blank.

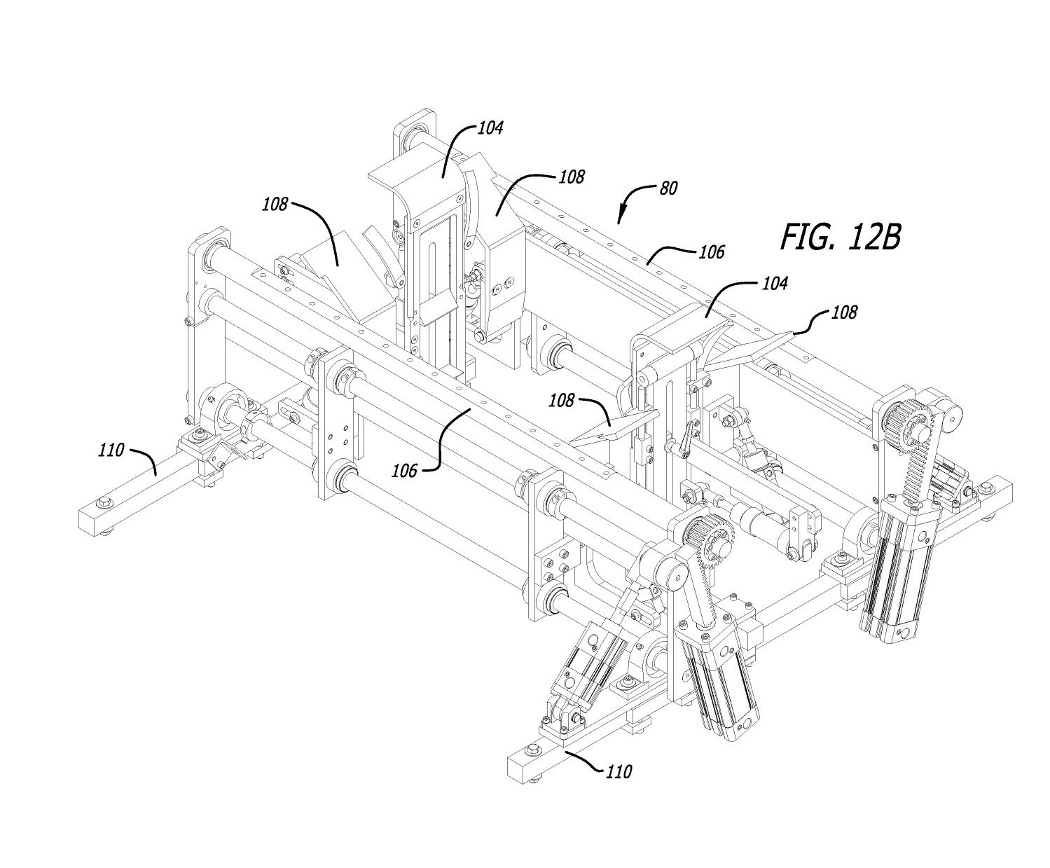

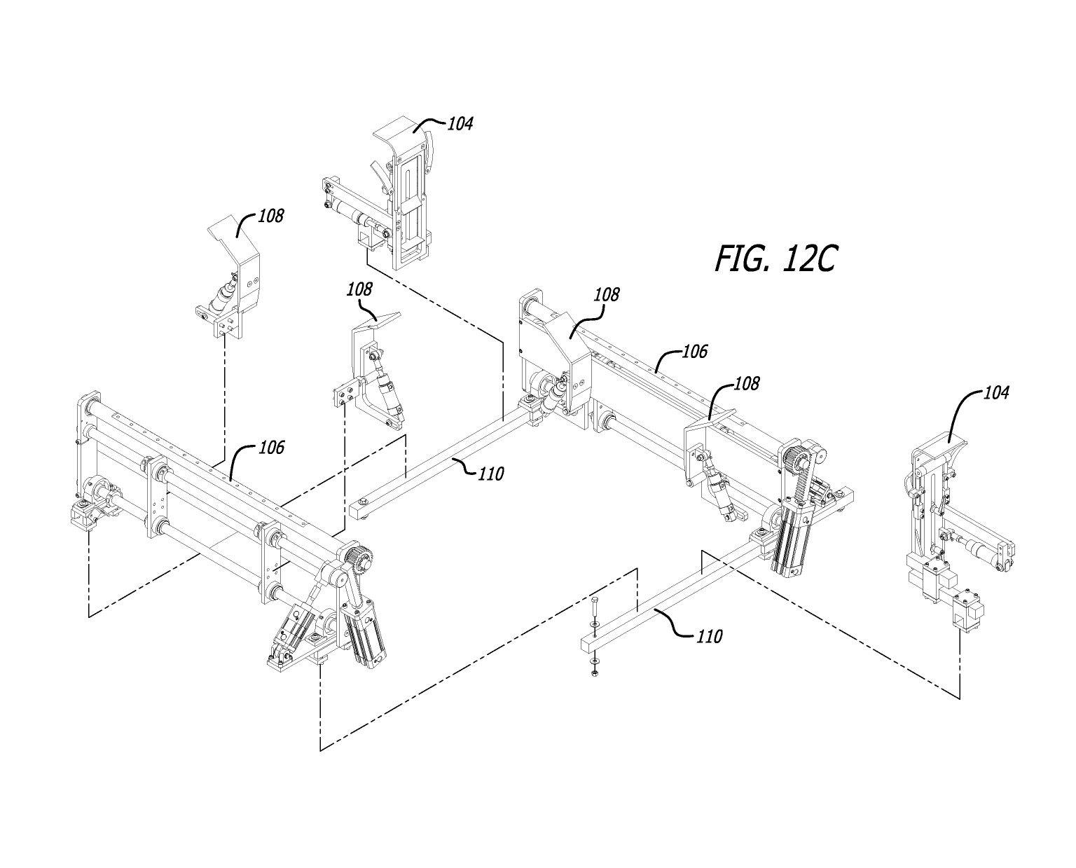

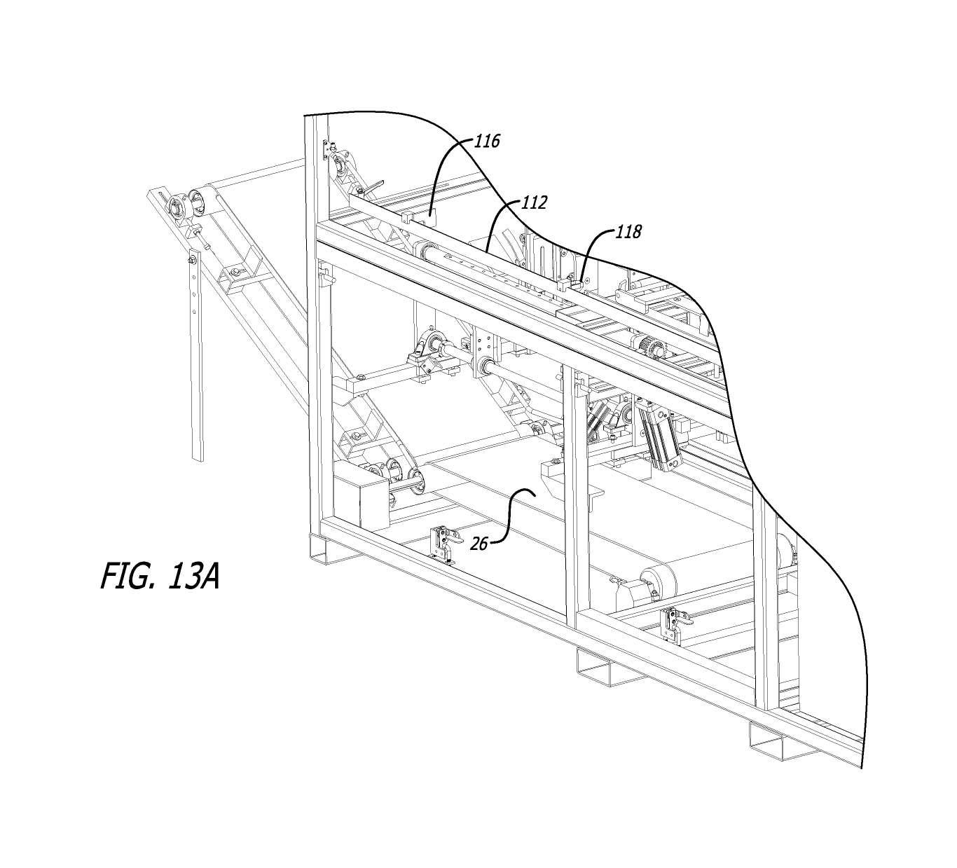

After the folding mechanism 80 associated in the first folding station 32 has finished it particular folding operation, the rear grabber assembly 66 engages the edge of the partially-folded blank and moves it from the first folding station 32 into the second folding station 34. Again, the movement of this partially-folded box blank is accomplished utilizing the same slider bar 62/ actuating drive 44 which initially moves the unfolded box blank into the first folding station. The folding mechanisms 80 associated with the second folding station 34 are again adapted to fold the particular box blank into the completed box. The specific folding mechanisms 80 of the second folding station 34 are shown in greater details in FIGS. 12A-12C.

The folding mechanisms 80 of the second folding station 34 are feed by the actuating drive 46 which is specifically adapted to perform this function. In this regard, the actuating drive includes a drive unit 94 which moves a forming mandrel 96 between upper and lower positions. FIGS. 11A-11D show the specific embodiment of the drive unit 94 and forming mandrel 96 used on the present embodiment. The drive unit 94 is very similar to the drive unit used to move the box blank from the feeding station 28 to the first folding station 32. A linear actuator 98 is attached to servo motor 100. During operation, the forming mandrel 96 remains in its upper position to allow a box blank to be position within the second folding station 34. Optical sensors 102 can be used to provide a signal that the box blank has ben properly placed in the feed position ready to be feed into the folding mechanisms 80. In the particular mandrel assembly shown in FIGS. 11A-11D, the forming mandrel 96 has substantially the same size and shape as the panel which forms the bottom panel of the formed box. At the second feed position, the forming mandrel 96 starts its downward stroke coming in contact with the box blank and moving it into the opening of the folding mechanisms 80 which are located directly beneath the folding mandrel 96. The moving of the box blank by the folding mandrel 96 causes the side flaps of the box blank to move upright forming the basic structure of the box. Thereafter, the forming mandrel 96 moves back to its original upper position to clear itself from the folding mechanism allowing the folding mechanisms to fold the flaps accordingly to create the competed box. The return stroke also places the forming mandrel 96 out of the path of the next incoming box blank which is to be positioned in the second folding station 34. Again, as is described above, the return stroke of the actuating drive 46 can be done at a speed that is greater than the forward stroke since precise blank alignment is not necessary.

The folding mechanisms 80 of the second folding station 34 are shown in greater detail in FIGS. 12A-12C. The folding mechanisms 80 include a pair of side forming assemblies 104, a pair of end panel guide assemblies 106, four compression assemblies 108 and a pair of support bars 110. The partially-folded box blank enters into the space defined between the end panel guide assemblies 106 and the side forming assemblies 104. The forming mandrel 96 is actuated to move the box blank into this space. Once the mandrel 96 has been removed, the various folding mechanisms are actuated to fold the respective flaps and tabs of the blank. The completed box is then released by the mechanisms and drops to the conveyor belt system 26 located directly beneath these mechanisms. During the time that the folding mechanisms are being actuated, another box blank can be advanced into the second folding station. Once the completed box is released by the folding mechanisms 80, the folding mandrel 96 is already to make contact with the next box blank to move it into the folding mechanisms 80.

The main frame which supports the various pieces of machinery is shown in FIG. 6. The main frame includes support columns and cross beams which provide the structure necessary to support the various folding and processing equipment. As can be seen in this figure, the main frame includes overhead rail supports used to mount the various glue assemblies and optical sensors. The main frame includes a pair of parallel rails 112 that are used to support the box blanks during the folding operation. These rails 112 extend from the feeding station to the second folding station. The edges of the box blank ride on these rails 112 through the folding process. A top rail 114 could be placed directly over the main rail 112 to create an elongate slot in which the edge of the box blank travels. Since only a small portion of the box blanks makes contact with these rail 112 during the folding operation and the drive means only engages the edge of the box blank, there is little chance that the printing on the box blank would become marred and damaged through the folding process.

A box stop assembly 116 is shown mounted on each of the rails 112 in the second folding station. These stop assemblies 116 provide an abutting stop to position the box blank on the second folding station. A pair of box rebound stops 118 are pivotally mounted on the rails 112 to allow the box blank to enter the second folding station but will prevent the blank from moving in a backward motion.

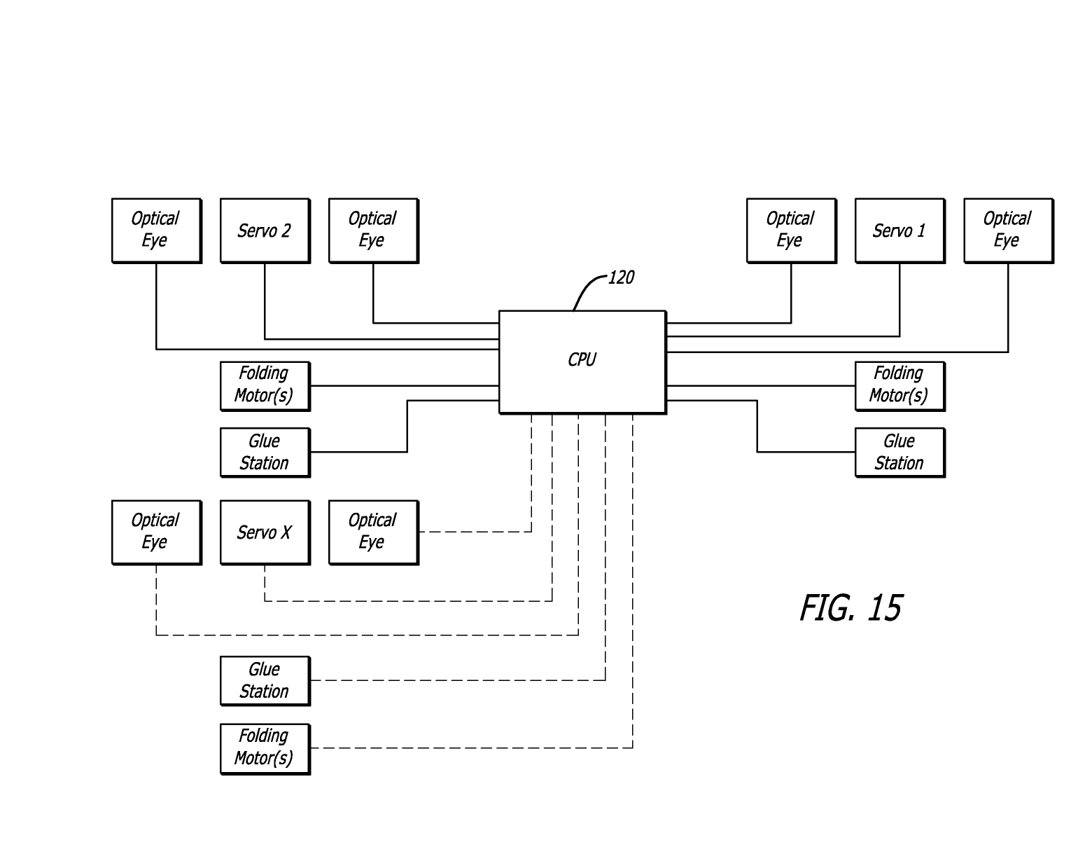

Referring now to FIG. 15, a schematic diagram which generally defines the control system 120 of the present invention is shown. The control system 120 of the apparatus is designated as a CPU which provides the control signals to the various mechanisms used in accordance with the present invention. In this regard, the control system 120 controls the first and second servos used with the actuating drives described herein. The control system controls additional actuating drives and servo systems which could be implemented for additional advancement/folding equipment. The control system also provides the necessary signals to activate the motors and drives which activate the various folding mechanisms. The glue assemblies can be controlled by this control system as well.

Suitable servo-pneumatic systems which can be used with the present invention consist of a controller and a linear drive unit with a displacement encoder are manufactured by Festo Corporation, 395 Moreland Road, Hauppauge, N.Y. 11788. The various glue assemblies are commercially available. Pneumatic regulators, pneumatic lines, and generating sources are commercially available. Particular box blanks which can be folded by the disclosed embodiment are manufactured by International Paper under the trademarks One Touch®, One Touch II® and Defor®. Still other box blanks manufactured by International Paper and other paper manufactures could be folded by the present invention. As is mentioned above, appropriate folding equipment may have to be used in place of the folding mechanisms described herein for different sized and shaped box blanks which could be folded in accordance with the apparatus and methods described herein.

While there have been described herein what are considered to be preferred and exemplary embodiments of the present invention, other modifications of the invention shall be apparent to those skilled in the art from the teachings herein and, it is therefore, desired to be secured in the appended claims all such modifications as fall within the true spirit and scope of the invention. Accordingly, what is desired to be secured by Letters Patent of the United States is the invention as defined and differentiated in the following claims.

I claim:

1. A box folding apparatus for folding a box blank, comprising:
a feeding station for receiving a box blank, the feeding station including an actuating drive controlled by a first servo system; and
a folding station including a folding mechanism for folding at least a portion of a box blank, the folding mechanism being associated with an actuating drive controlled by a second servo system operating independently from the first servo system, wherein the actuating drive of the feeding station moves the box blank into the folding station and has variable speed controlled by the first servo system and the actuating drive of the folding mechanism moves the box blank into the folding mechanism and has variable speed controlled by the second servo system.

2. The box folding apparatus of claim 1, wherein the actuating drive of the feeding station has a forward linear stroke and a reverse linear stroke and the speed of the forward and rear linear strokes can be varied by the first servo system.

3. The box folding apparatus of claim 1, wherein the actuating drive associated with the folding mechanism has a forward linear stroke and a reverse linear stroke and the speed of the forward and rear strokes of the actuating drive associated with the folding mechanism can be varied by the second servo system.

4. The box folding apparatus of claim 2, wherein the actuating drive associated with the folding mechanism has a forward linear stroke and a reverse linear stroke and the speed of the forward and rear strokes of the actuating drive associated with the folding mechanism can be varied by the second servo system

5. The box folding apparatus of claim 4, wherein the forward linear stroke of the actuating drive of the feeding station moves the box blank from the feeding station to the folding station.

6. The box folding apparatus of claim 5, wherein speed of the forward linear stroke of the actuating drive of the feeding station is less than the speed of the rear linear stroke.

7. The box folding apparatus of claim 6, wherein speed of the forward linear stroke of the actuating drive associated with the folding mechanism is less than the speed of the rear linear stroke of the actuating drive associated with the folding mechanism.

8. The box folding apparatus of claim 7, further including an actuating mechanism which places a box blank onto the actuating drive of the feeding station.

9. The box folding apparatus of claim 1, further comprising a second folding station having a folding mechanism which folds a portion of the box blank.

10. A box folding apparatus for folding a box blank, comprising:
a feeding station including an actuating drive controlled by a first servo system; and
a folding station including a folding mechanism for folding a portion of a box blank, the folding mechanism including an actuating drive controlled by a second servo system operating independently from the first servo system, wherein the actuating drive of the feeding station moves a box blank into the folding station, the actuating drive of the feeding station having a first speed for moving the box blank from a first feed point on the feeding station into the folding station and a second speed for moving the actuating drive back to the first feed point, the actuating drive of the folding mechanism having a first speed for moving a box blank from a second feed point into the folding mechanism and a second speed for moving the actuating drive of the folding mechanism back to the second feed point.

11. The box folding apparatus of claim 10, wherein the first speed of the actuating drive of the feeding station is less than the second speed of actuating drive of the feeding station.

12. The box folding apparatus of claim 11, wherein the first speed of the actuating drive of the folding mechanism is less than the second speed of actuating drive of the folding mechanism.

13. A box folding apparatus for folding a box blank, comprising:
a feeding station including an actuating assembly associated with the feeding station; a hopper assembly for holding a stack of box blanks therein, a feed assembly associated with the hopper assembly for engaging a box blank in the hopper assembly and moving it to a first feed point;
a first folding station adjacent to the feeding station including a folding mechanism for folding a portion of a box blank;
a second folding station adjacent to the first folding station including a folding mechanism for folding a portion of the box blank; and
wherein the actuating assembly includes an actuating drive controlled by a first servo system which produces a forward linear stroke that moves a box blank placed in the first feed position into the first folding station and simultaneously moves a box blank located in the first folding station into the second folding station.

14. The box folding apparatus of claim 13, wherein at least one of the first and second folding stations includes an actuating drive associated with the folding mechanism, the actuating drive associated with the folding mechanism being controlled by a second servo system operating independently from the first servo system, wherein the actuating drive associated with the folding mechanism can produce a variable actuating speed to move a box blank into the folding mechanism.

15. The box folding apparatus of claim 14, wherein the actuating drive associated with the folding mechanism drives a mandrel with a forward linear stroke which contacts and moves a box blank from a second feed position into the folding mechanism and a reverse linear stroke which moves the mandrel back to the second feed position.

16. The box folding apparatus of claim 14, wherein the actuating drive associated with the folding mechanism is located on the second folding station.

17. A box folding apparatus for folding a box blank, comprising:
a feeding station including a hopper assembly for holding a stack of box blanks therein, a feed assembly associated with the hopper assembly for engaging a box blank in the hopper assembly and moving it to a first feed position;
a first folding station adjacent to the feeding station including a folding mechanism for folding a portion of a box blank;
a second folding station adjacent to the first folding station including a folding mechanism for folding a portion of the box blank; and
an actuating assembly associated with the feeding station, the actuating assembly having an actuating drive controlled by a first servo system which produces a forward linear stroke which moves a box blank placed at the first feed position into the first folding station and simultaneously moves a box blank located in the first folding station into the second folding station.

18. The box folding apparatus of claim 17, wherein the feed assembly includes a plurality of vacuum cups in communication with a vacuum source which draws a vacuum to engage the box blank and an actuating drive which moves the plurality of vacuum cups and box blank from the hopper to the first feed position.

19. The box folding apparatus of claim 17, wherein the second folding station includes an actuating drive associated with the folding mechanism, the actuating drive associated with the folding mechanism being controlled by a second servo system operating independently from the first servo system.

20. The box folding apparatus of claim 19, wherein the actuating drive associated with the folding mechanism can produce a variable actuating speed to move a box blank from a second feed position into the folding mechanism.

21. A method for folding a box blank into a box, comprising:
engaging a box blank with a first actuating drive controlled by a first servo system at a first feed position;
activating the first actuating drive to move the box blank from the first feed position into a folding station which includes a folding mechanism for folding at least a portion of a box blank, the folding mechanism being associated with a second actuating drive controlled by a second servo system operating independently from the first servo system;
activating the second actuating drive to move a mandrel which engages and moves the box blank from a second feed position into the folding mechanism;
activating the second actuating drive to move the mandrel out of the folding mechanism; and
activating the folding mechanism to fold a portion of the box blank to form a box.

22. The method of claim 21, further including:
returning the first actuating drive to the first feed point to engage another box blank.

23. The method of claim 22, wherein the first actuating drive moves the box blank into the folding station at a first speed and the returning of the actuating drive to the first feed position is done at a second speed.

24. The method of claim 23, wherein the second actuating drive moves mandrel and the box blank into the folding mechanism at a first speed and the second actuating drive returns the mandrel to the second feed position at a second speed.
